(19) United States
(12) Patent Application Publication
(10) Pub. No.: US 2005/0025320 A1
(43) Pub. Date: Feb. 3, 2005

(54) Multi-media apparatus

(76) Inventor: James Anthony Barry, Dublin (IE)

Correspondence Address: Ronald J Baron;Hoffmann & Baron, 6900 Jericho Turnpike, Syosset, NY, 11791, US

(21) Appl. No.: 10/490,195

(22) PCT Filed: Oct. 9, 2002
(86) PCT No.: PCT/IE02/00142

(30) Foreign Application Priority Data
Oct. 9, 2001 (IE) S 2001/0895
Jun. 26, 2002 (IE) S 2002/0519

(51) Int. Cl. H04B 1/00

(52) U.S. Cl. 381/119; 715/723

(57) ABSTRACT

Interactive multimedia apparatus (an operating device), shown in 4 views, is coupled to a control unit comprising a PC (personal computer) or similar system with a software suite of programs. The apparatus has activation means, including a plurality of buttons and an analog element, forming dynamic intervention means to modify, refine, adjust, vary and/or change characteristics, parameters and special effects of individual audio or video tracks and/or characteristics and parameters and special effects of a composite audio mix during the mixing cycle in real time, and to record such changes. The functions of the activation means can be set by the user. The PC displays the tracks being mixed, and the pre-selected mixing effects chosen, and permits track file management. The apparatus may comprise foot operated means (e.g. a dance mat) or a steering wheel, or be wholly integrated.

The present invention relates to a multimedia apparatus and in particular to an interactive multimedia apparatus.

Electronic mixing software for PC and computer based products is known and there are packages available both commercially and as freeware over the internet. These packages allow users create tracks which contain loops, riffs, beats, one shots or the contents of a CD, track, microphone inputs, video files etc and to mix them together to produce their desired sound output compilation. The user places each selected loop, riff, one shot, video clip, CD output, microphone input etc. in a selected track position along the time axis ruler bar so that they are mixed at that time in the play cycle. The content, which can be WAV, MP3, WMA or any other digital media format being mixed, has been prepared at a recorded tempo and is of a fixed length of time. The desired mix will usually contain multiple tracks of differing beats, loops, riffs, one shots, voices, video etc. When the mixing process commences, a play-bar indicator moves across the time axis ruler over each track to indicate the position within each track where the mix is occurring.

Most digital mixing software packages allow the user to set up a series of controls and effects for each channel in advance of the mixing process occurring and will also allow some limited global control of the composite mix output. The control and effects are usually applied in advance of the mixing process occurring, but some limited control is allowed during the mixing cycle. Some of the individual track parameters, which are allowed to be altered during the mixing process, would include volume, mute, tempo and tone. Special effects are not normally allowed during the mixing process.

There are a very limited number of mixing packages that allow users to connect a Musical Instrument Digital Interface (MIDI) device like a keyboard or guitar to interface with their mixing package. These MIDI devices are expensive and usually require additional hardware or software to allow them to connect to a PC or other programmable computing devices. These software mixing packages with a MIDI peripheral interface allow the user to assign a loop, beat, riff or one shot to a key on the piano keyboard, which when depressed will trigger the software to play the pre-selected content assigned to that key for the duration of the key-press, which will then be mixed at the time of the key depression in the mixing cycle. The experience and effect is similar to assigning an on/off function to a key on a standard PC keyboard. In some software mixing packages a graphic of a piano keyboard is presented to the user on the screen; the user can assign an individual key which, when selected by the mouse or keyboard button, will trigger an event or a mix track to play at that time in the mix cycle.

There are many digital software music-editing packages available on the market both commercially and as freeware over the internet. These packages allow the user to edit riffs, loops, beats, one shots, CD outputs and other media context by cut, paste, copy and other known techniques for editing digital content. The editing process requires the user to select a portion of the waveform and reposition or alter the characteristics and parameters of the waveform. The user can change the characteristics of the waveform, add effects, move it or reposition it with the same track, cut and paste it or copy it to a newly created track. The editing process is accomplished by using either a mouse or a keyboard or a combination of both. If the user wishes to use only a segment of a loop, beat, riff, one shot, video clip, microphone input etc they must first pre-edit it and then insert it in a track in its play position along the time axis ruler to be mixed at that predefined time in the mix cycle.

The existing digital mixing and editing software packages provide a “two dimensional” experience, where the track components are placed on the screen in fixed positions along the time axis ruler with pre-assigned effects parameters.

An example of an interactive multimedia apparatus is shown in the applicant's own International patent application as published under Serial No. WO 01/95052 on Dec. 13^{th} 2001, after the earliest priority date of the present application.

The present invention provides an interactive multimedia apparatus, usable in combination with a software suite of programs installed in a computing means with a display component and a suitable input connection port to connect to the apparatus, characterised in that the apparatus includes dynamic intervention means to modify, refine, adjust, vary and/or change characteristics, parameters and special effects of individual audio or video tracks and/or characteristics and parameters and special effects of a composite audio mix during the mixing cycle in real time.

Specifically, the other novel features of the invention are defined in the appended Claim 2 to 24 which are incorporated into this description by reference.

The preferred form of the invention allows users to record all the controls, parameters and special effects details of the composite mix, including the dynamically applied controls, parameters, and effects initiated by the activation of the control members of the interactive multimedia device, which have been affected during the mix cycle. Moreover, the user is provided with a visual representation in the form of a pictogram or other representation of each track in the mix displayed on a visual display unit and the exact position in time that the intervention occurred in the mix cycle, with highlighted blocks which shows where additional, deletion or modifications, control changes, parameter changes and/or special effects have been applied as a result of the user's intervention by the activation of a control member of the interactive multimedia device. The representation of the pictogram represented on the visual display unit will also illustrate the control changes, parameter changes and special effects applied to the composite mix characteristics with the exact position in time where these events occurred.

The invention will hereinafter be more particularly described with reference to the accompanying drawings which show, by way of example only, a number of embodiments of a multimedia system according to the invention. In the drawings:

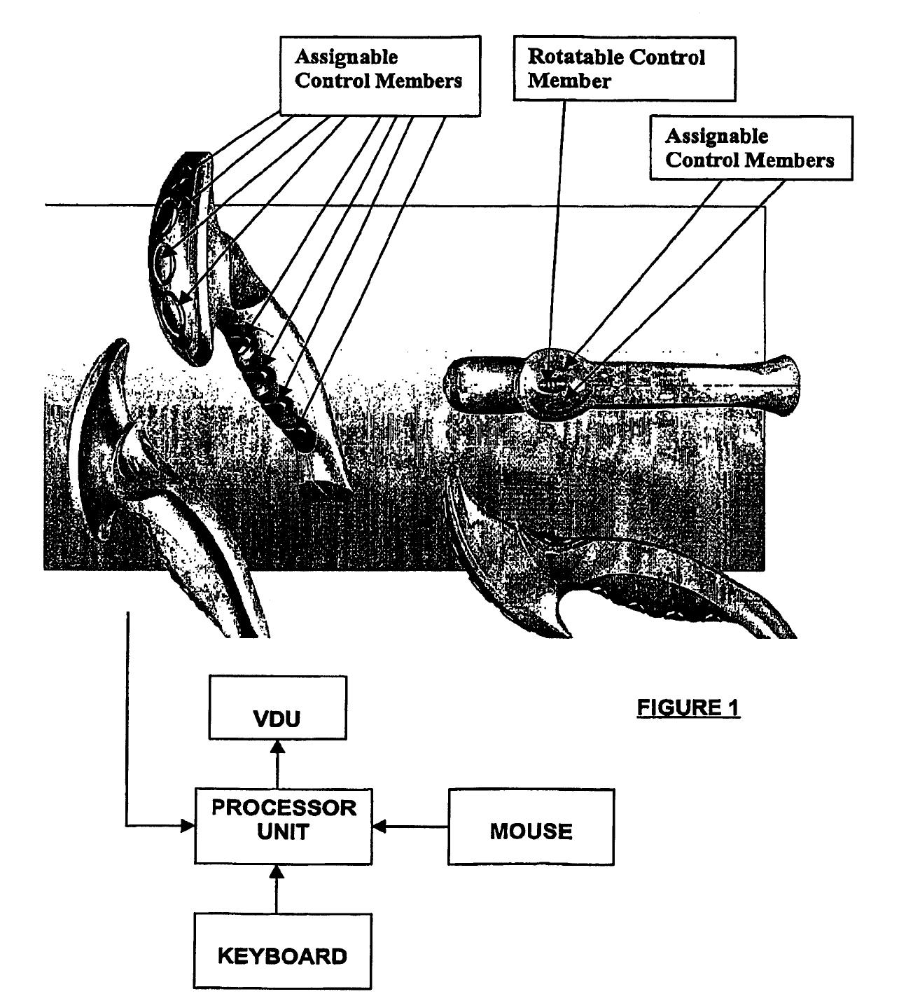

FIG. 1 is a general view of the system, including series of views illustrating a first embodiment of an operating device;

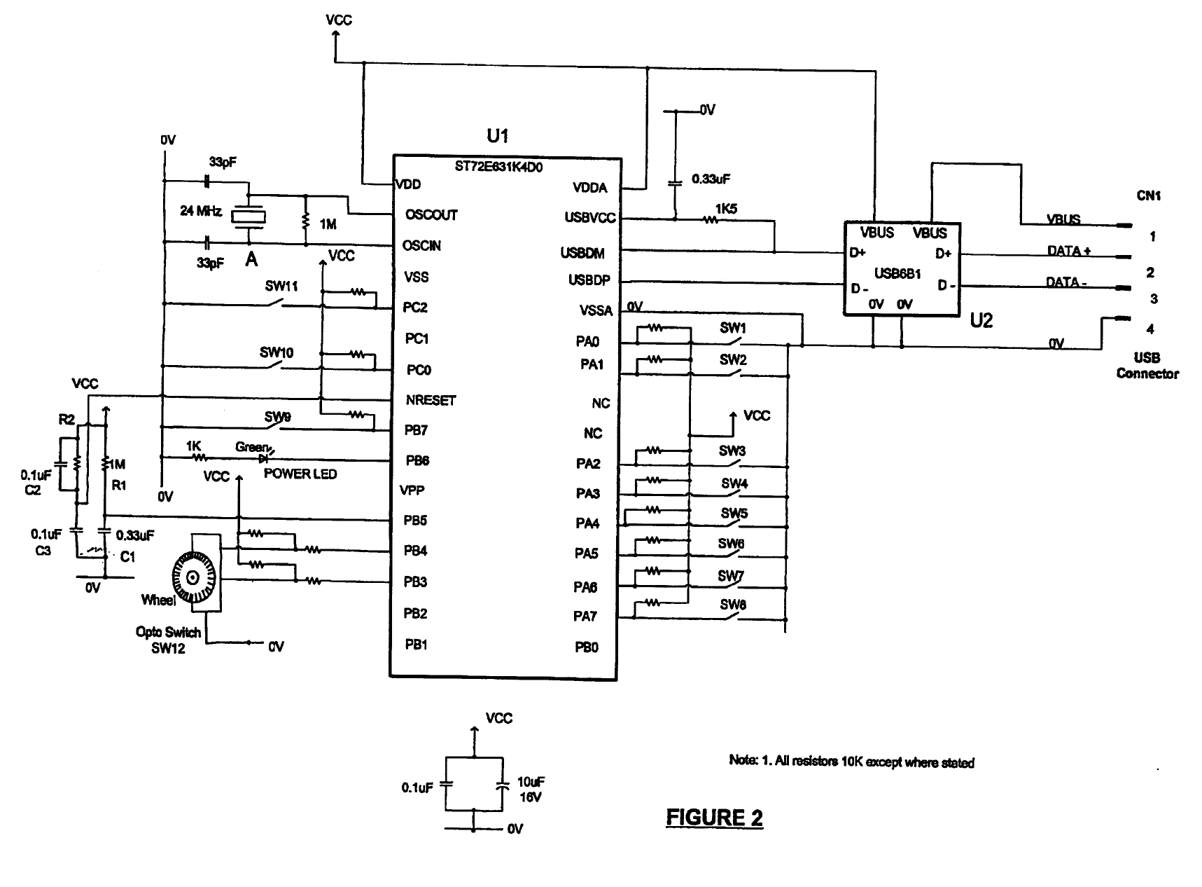

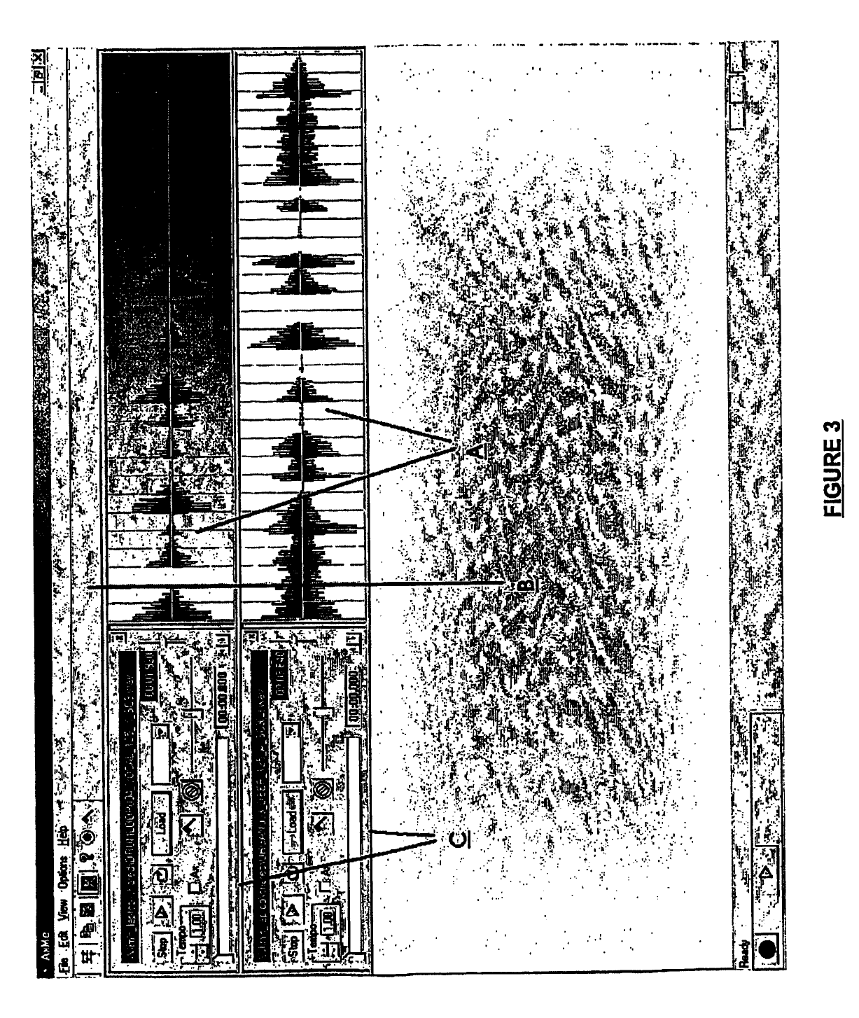

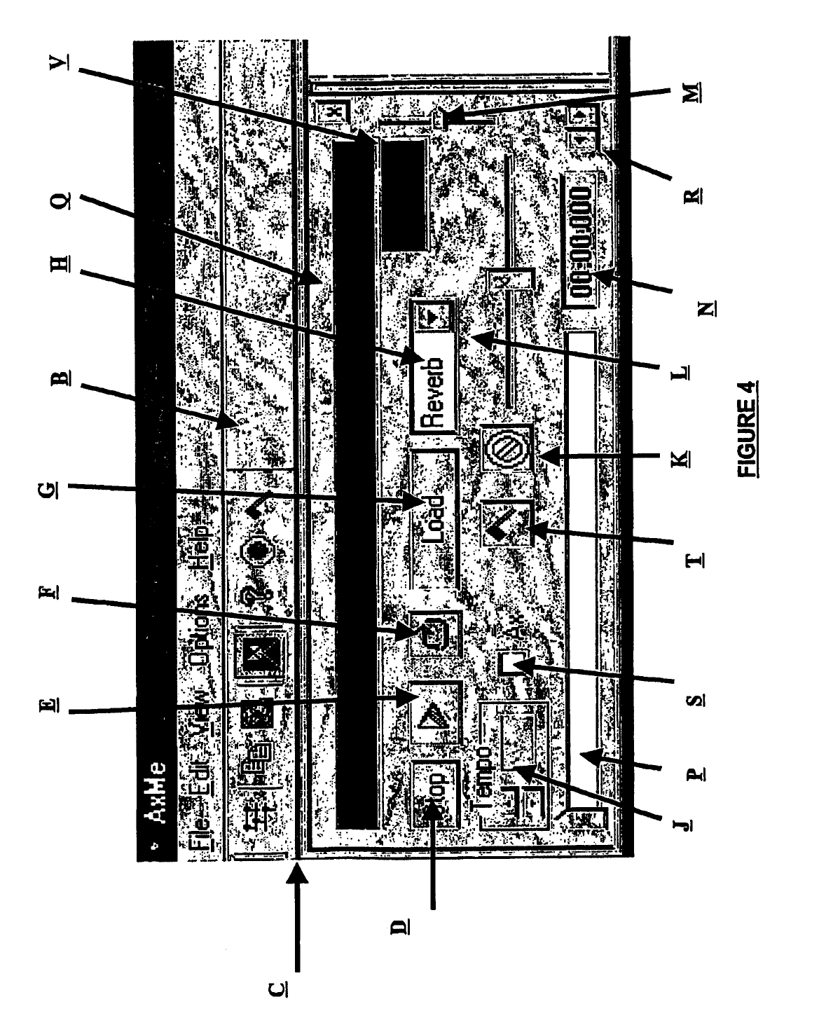

FIG. 2 is a schematic circuit diagram of the operating device;

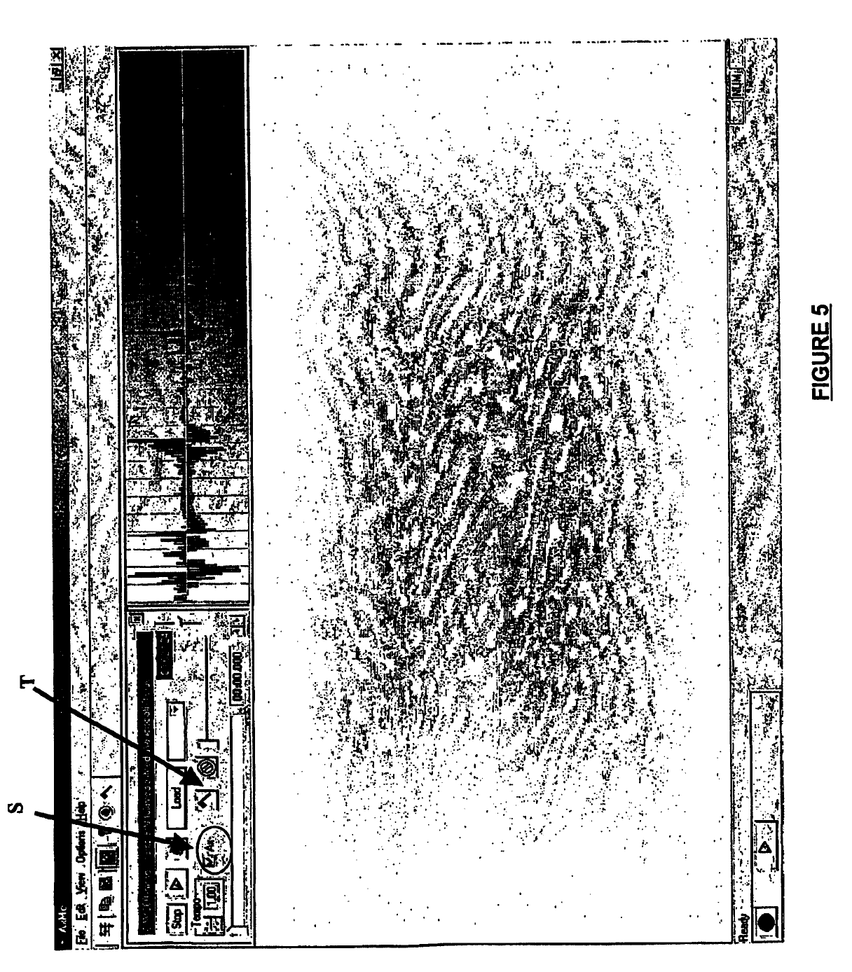

FIG. 3 shows the basic screen layout;

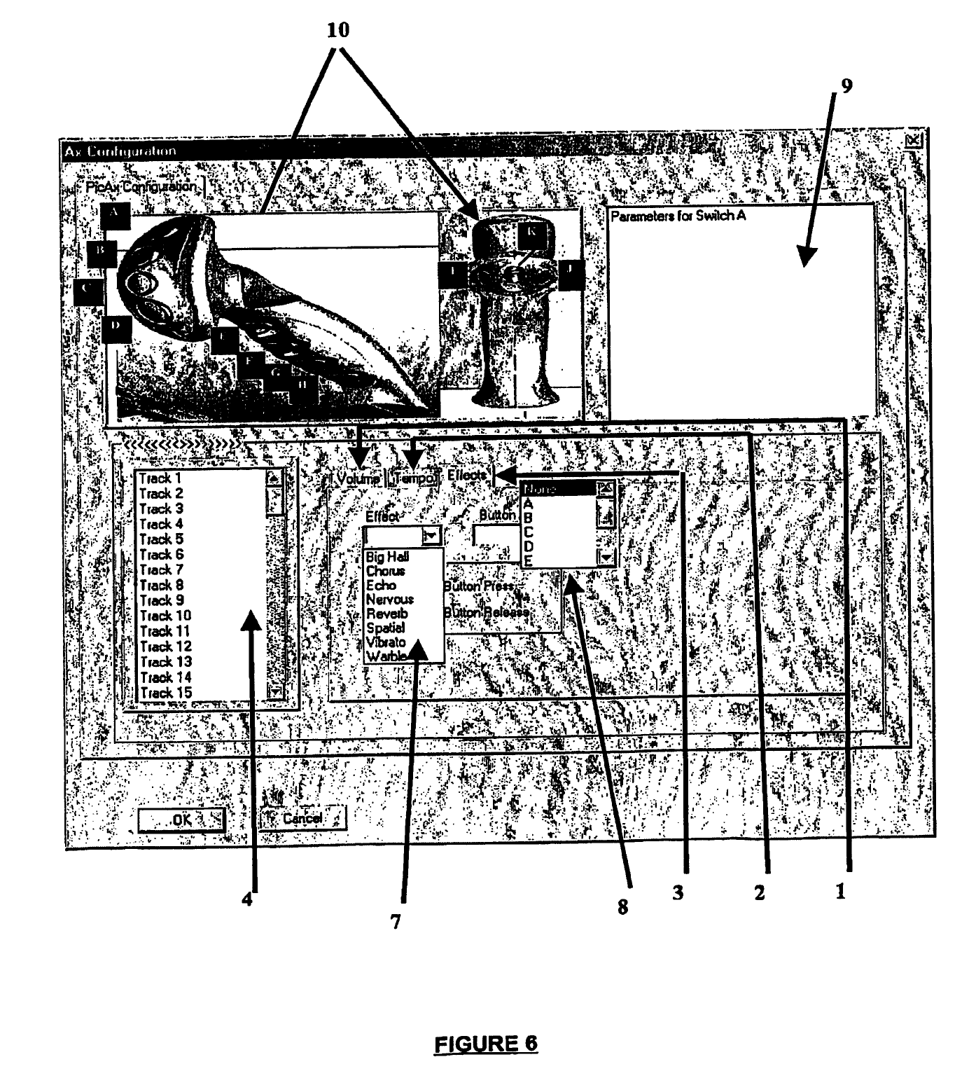

FIG. 4 illustrates the standard track controls;

FIG. 5 shows the assignment controls to the interactive multimedia apparatus;

FIG. 6 shows the apparatus configuration screen;

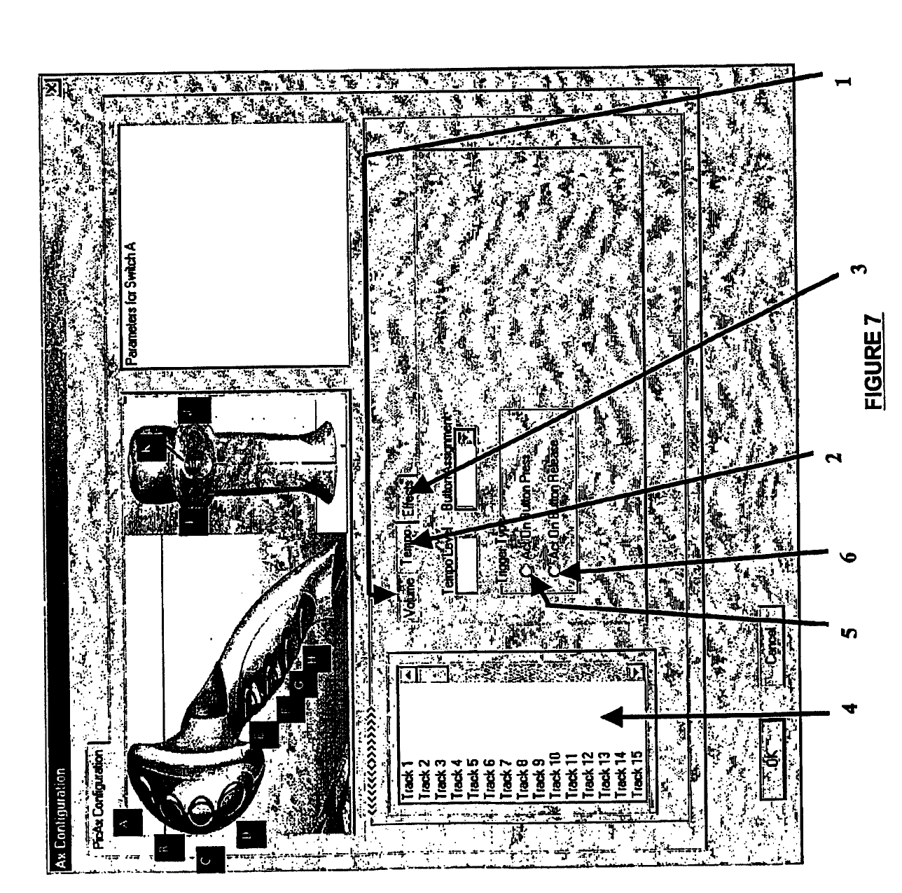

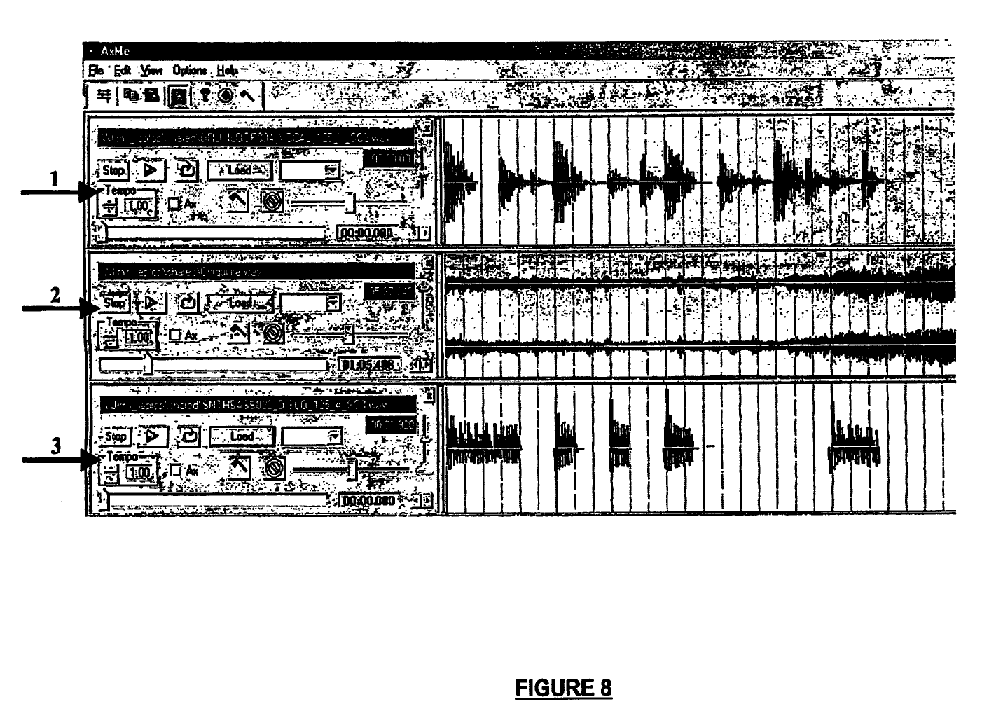

FIG. 7 shows a trigger type sub-menu for FIG. 6;

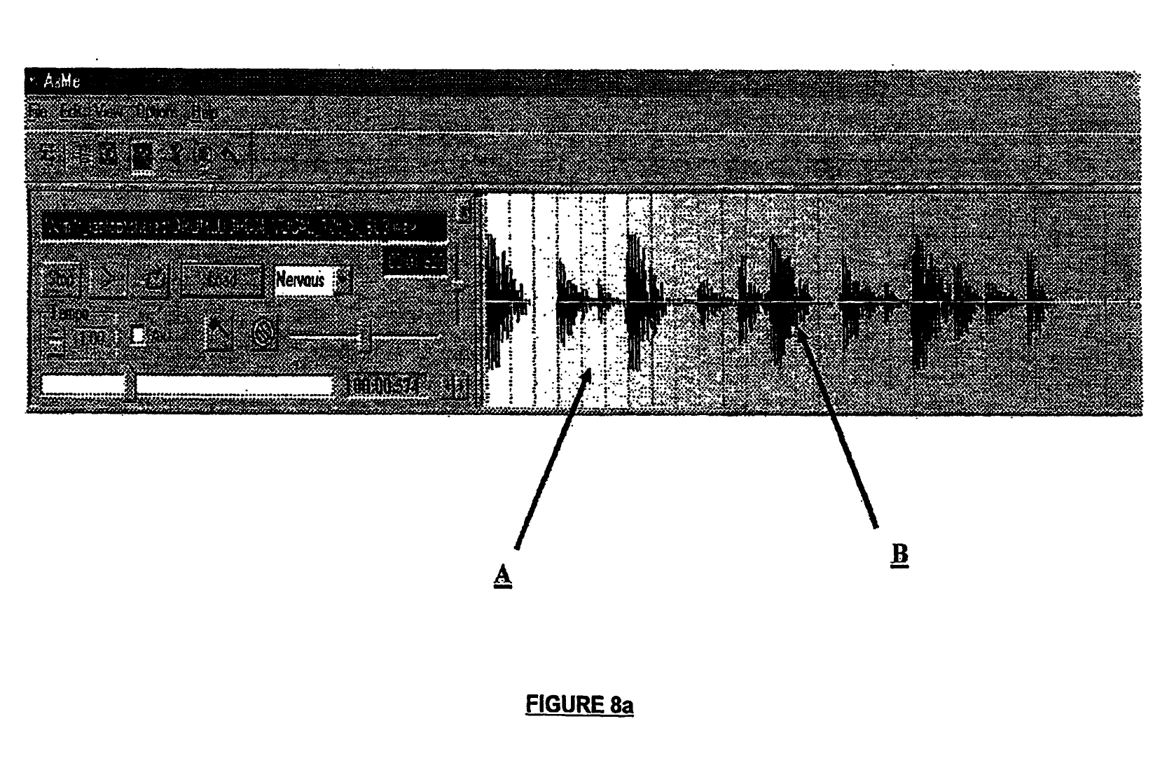

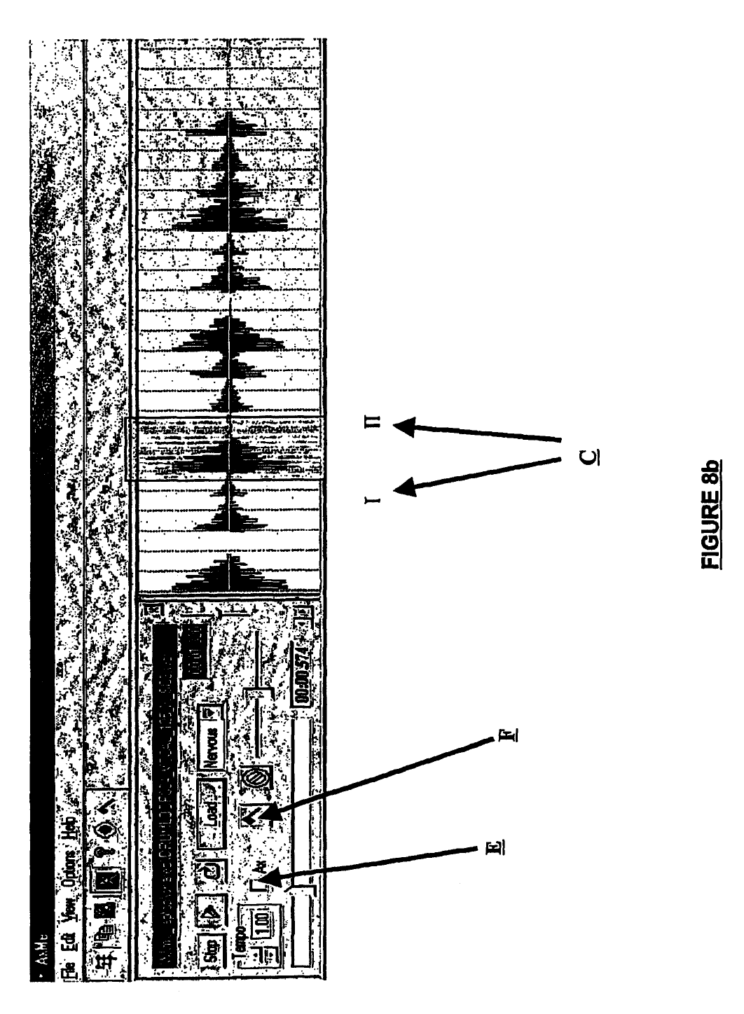

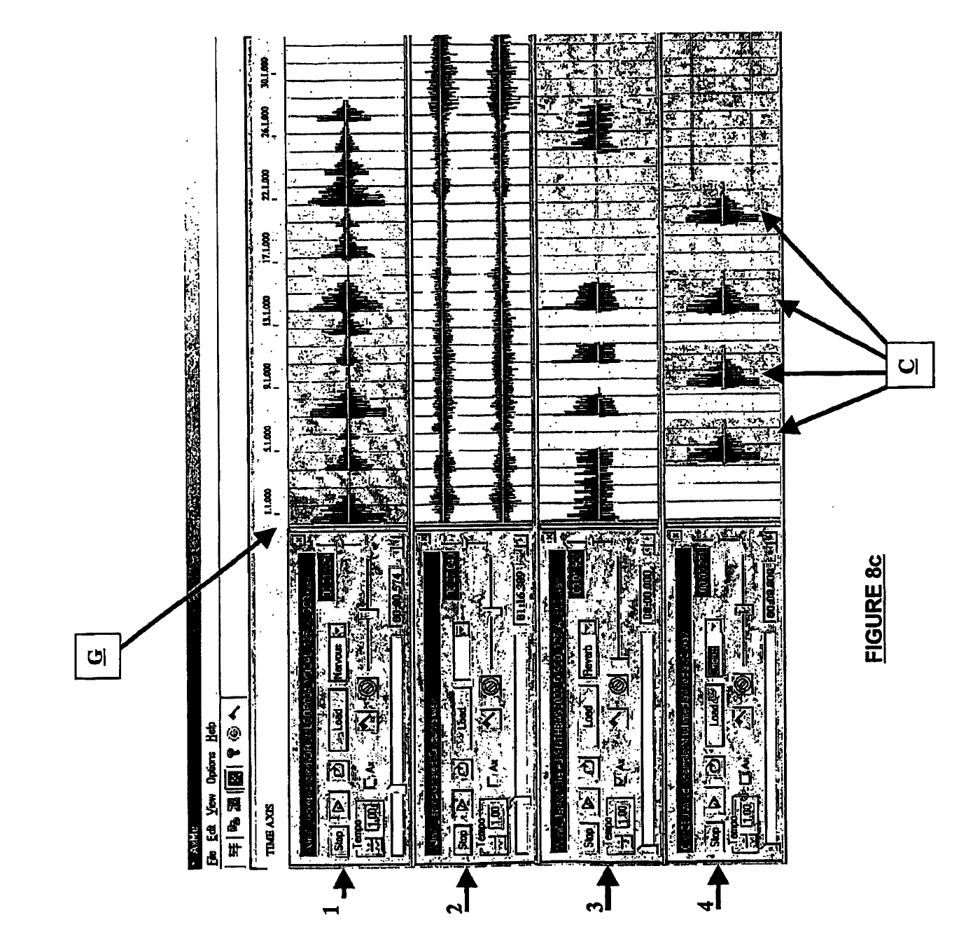

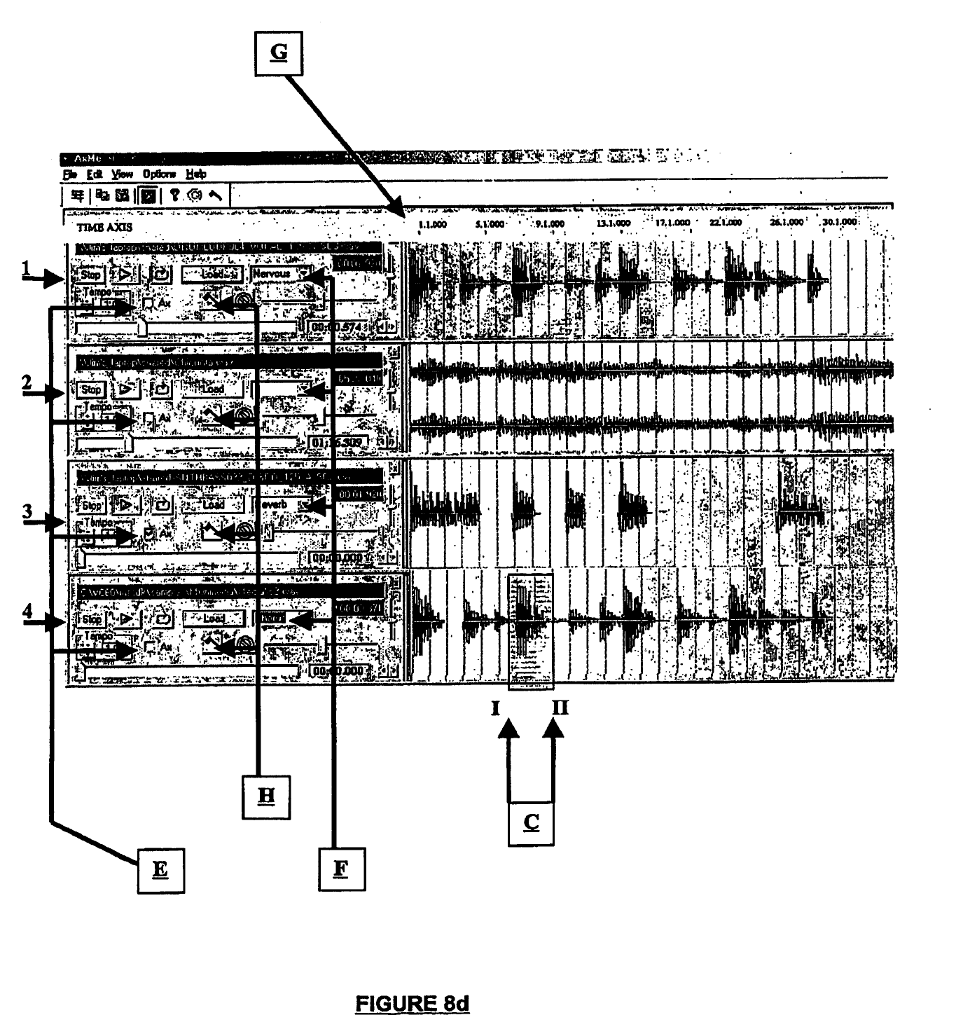

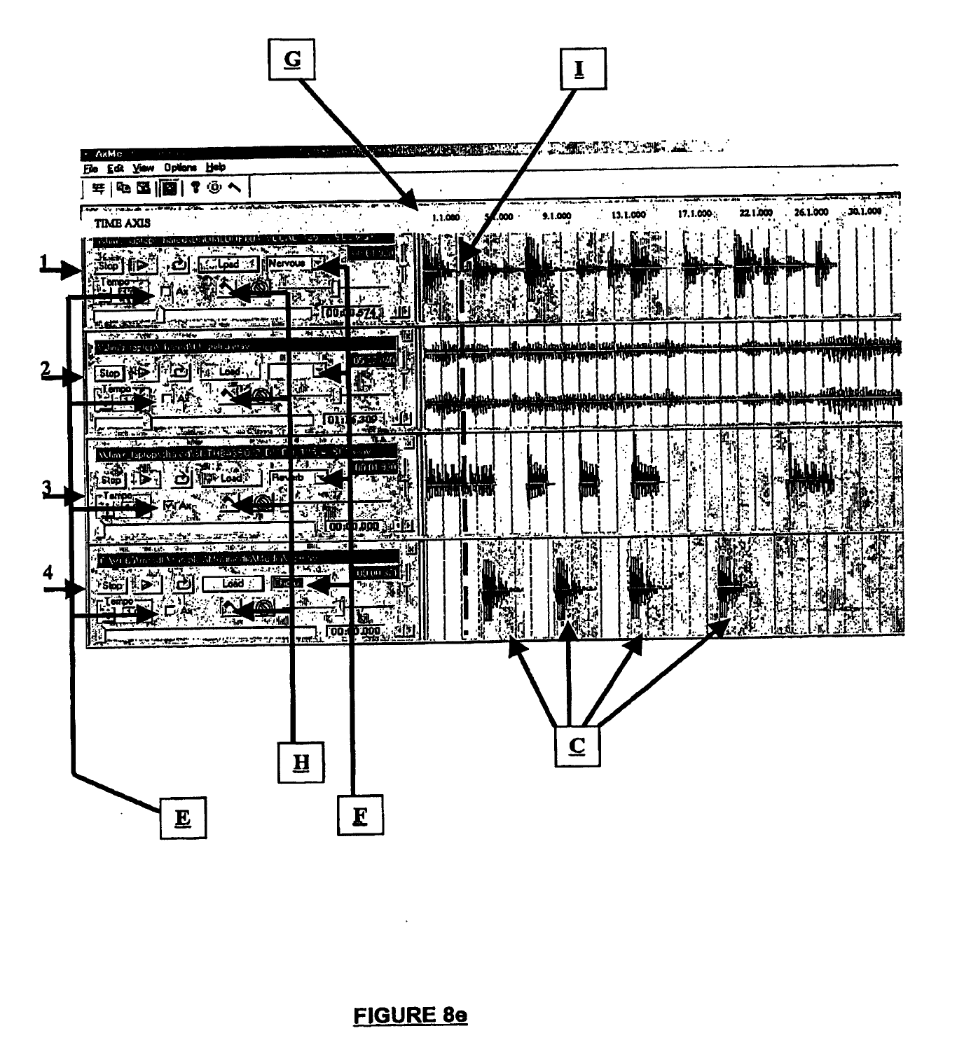

FIGS. 8 and 8A to 8C show a conventional mixing process;

FIGS. 8D and 8E show the present mixing process;

FIG. 8F shows a pictogram of the present process;

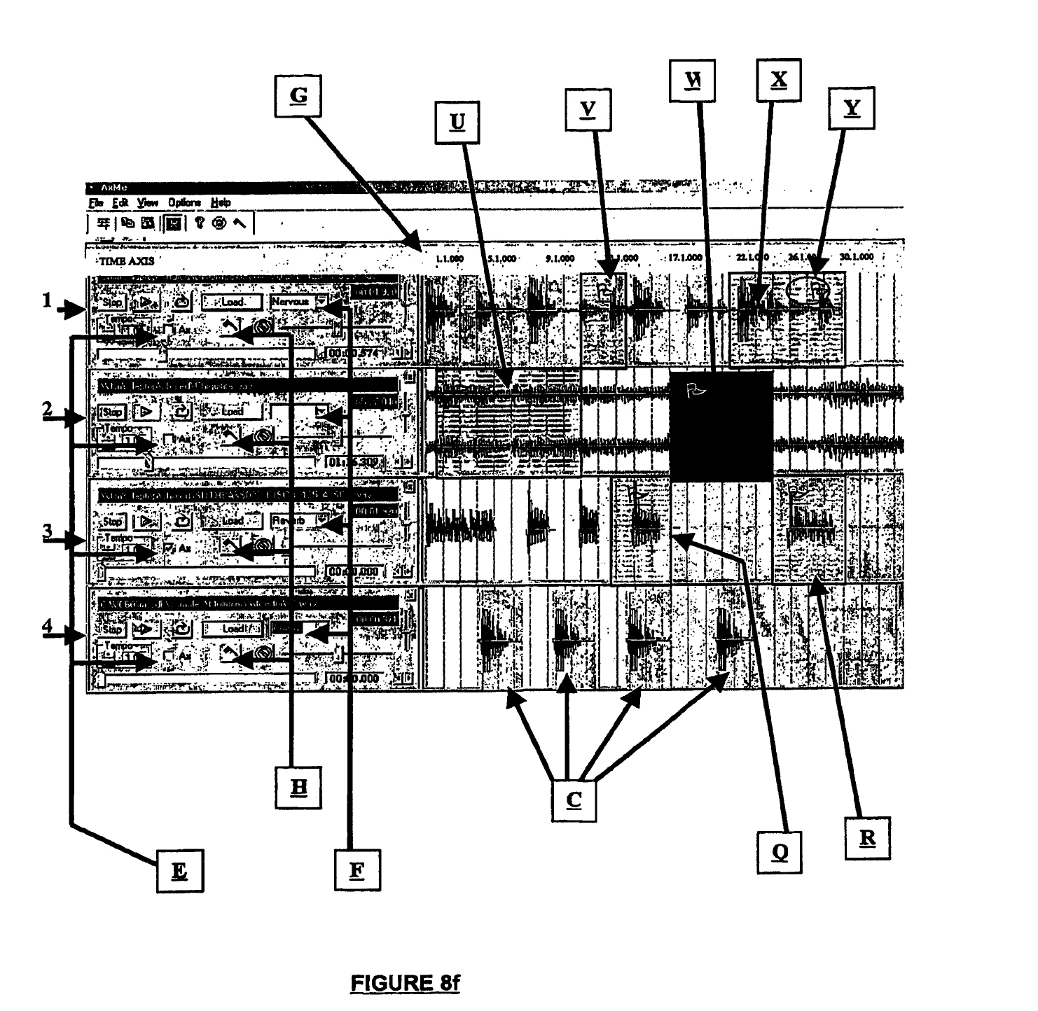

FIG. 9 shows a screen with a directory listing;

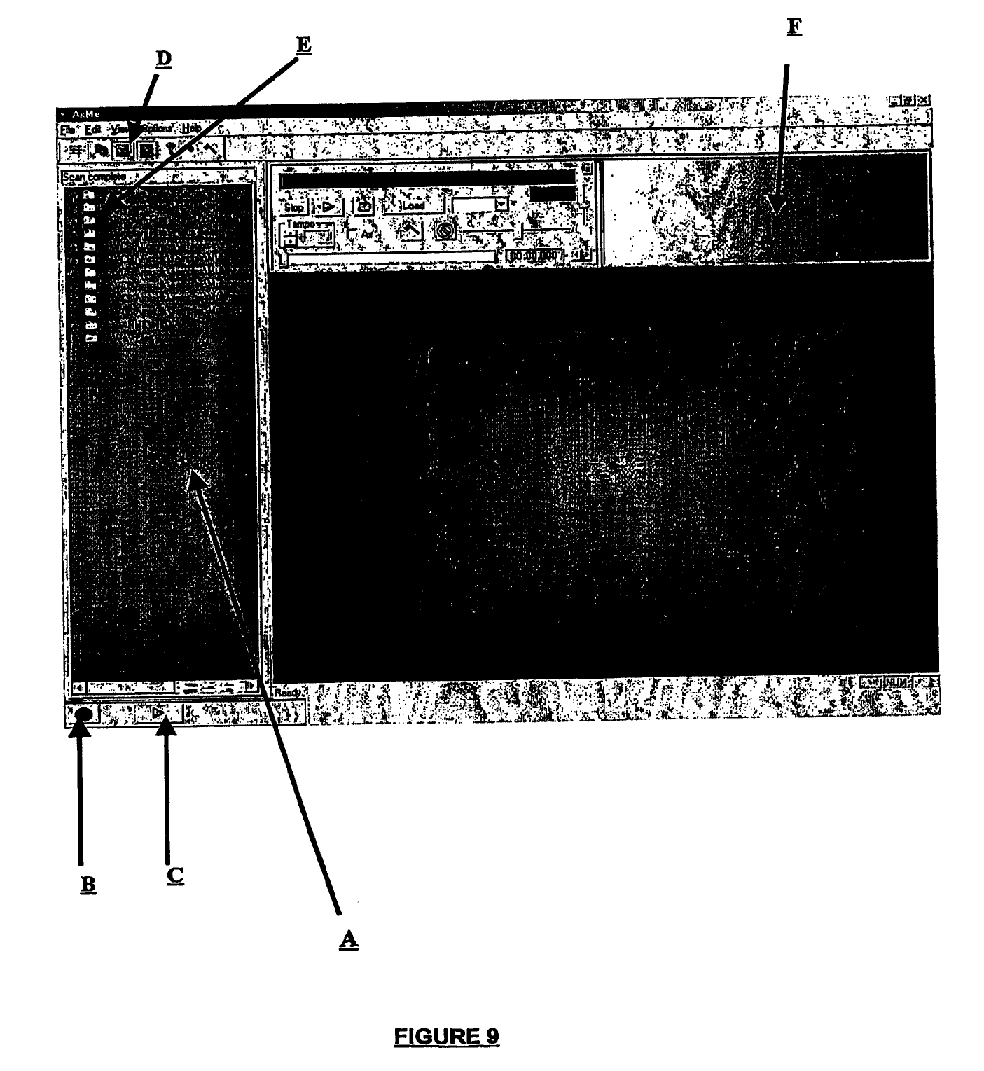

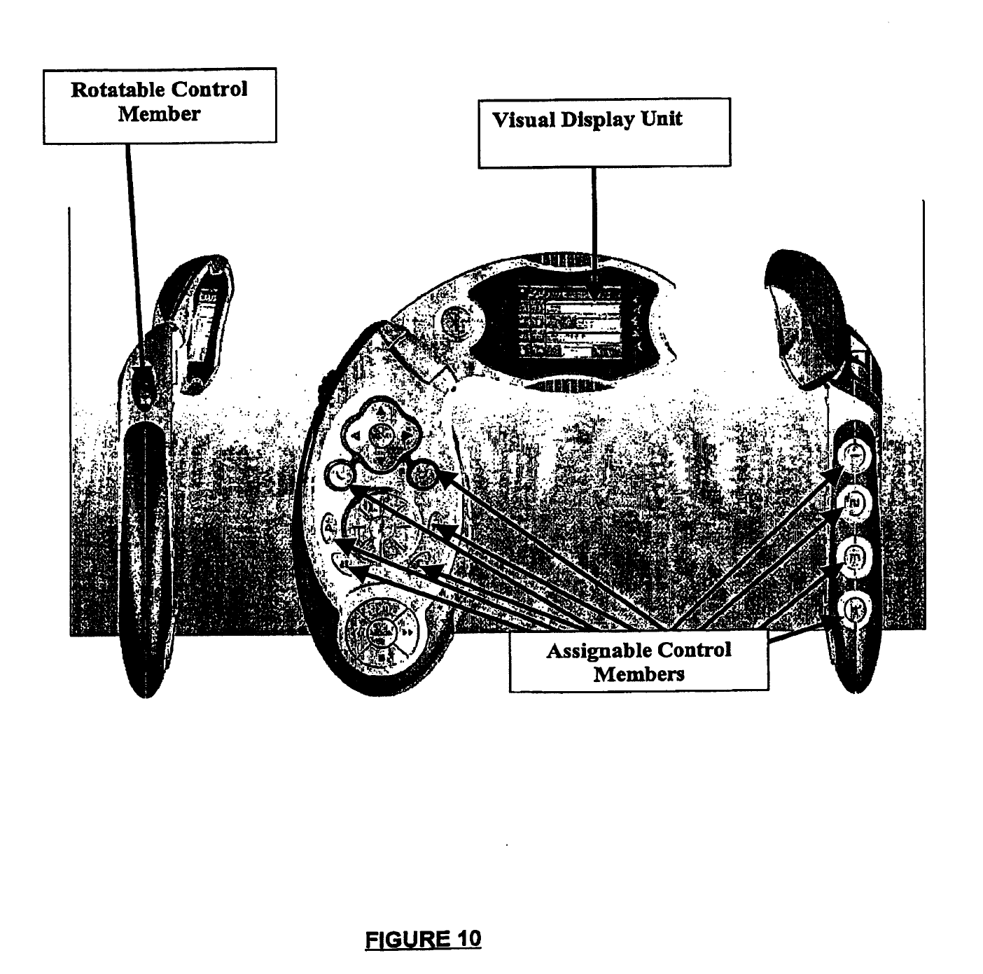

FIG. 10 is a series of views illustrating a second embodiment of a multimedia apparatus;

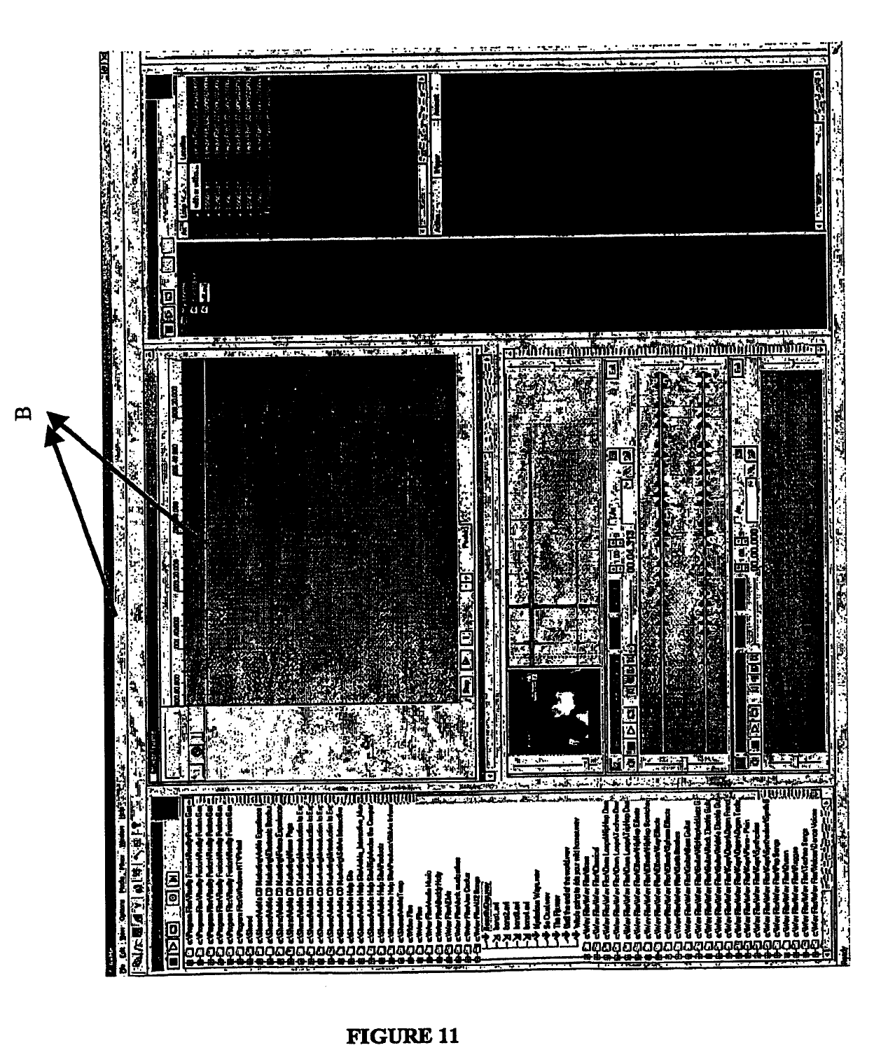

FIG. 11 shows a loop repository/loop store area;

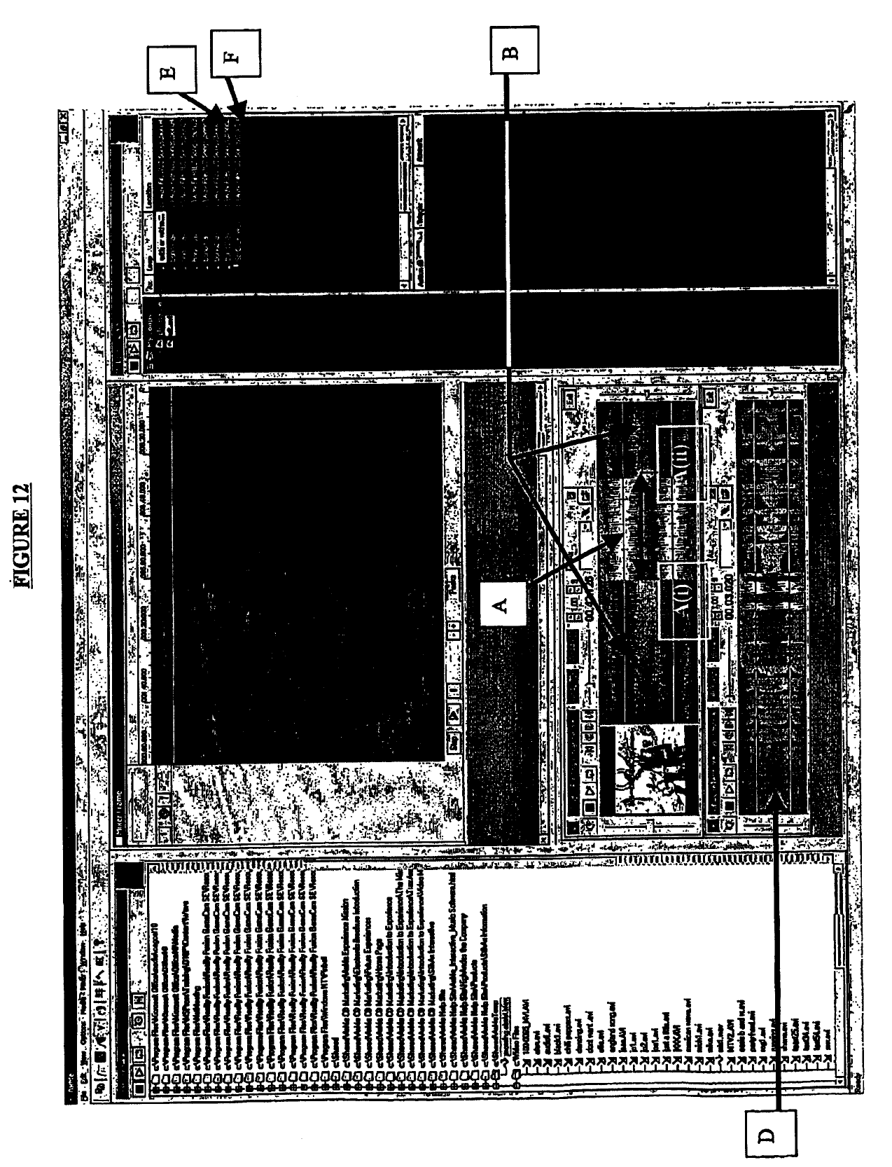

FIG. 12 shows the manipulation of tracks of data;

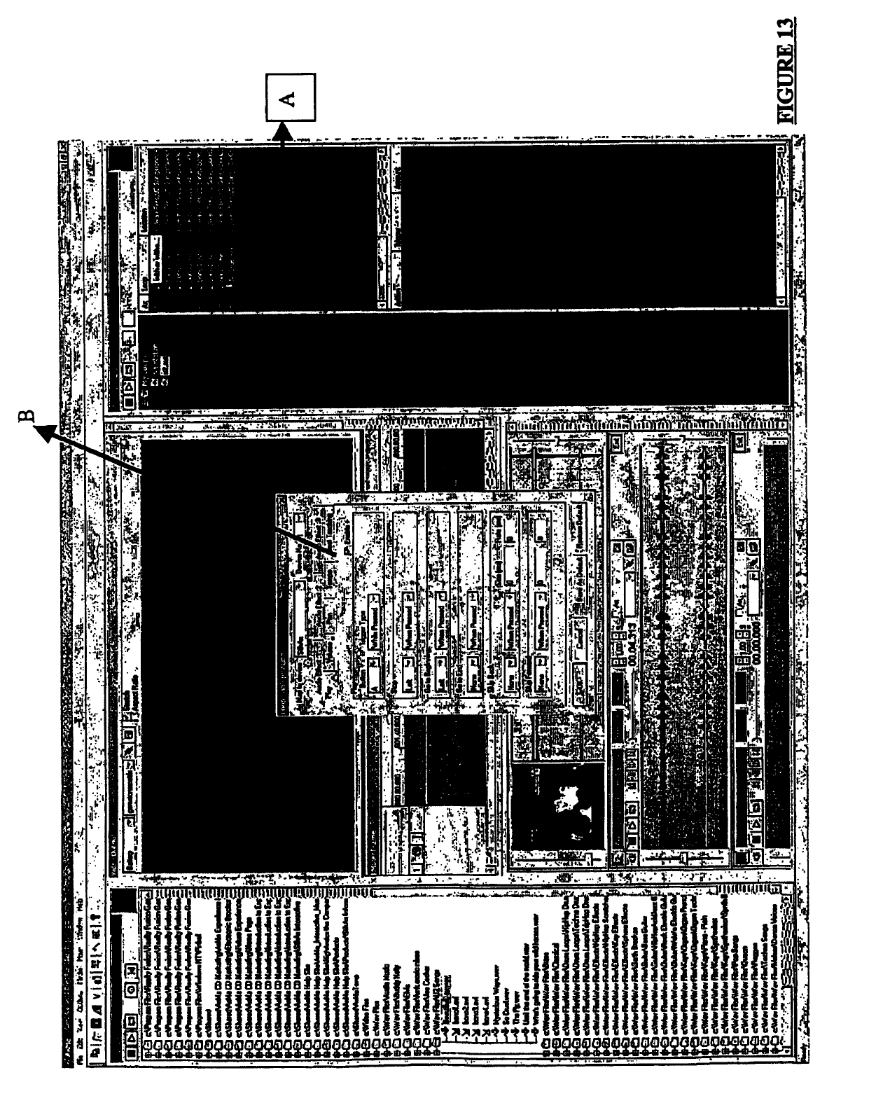

FIG. 13 illustrates the assignment of controls, effects etc;

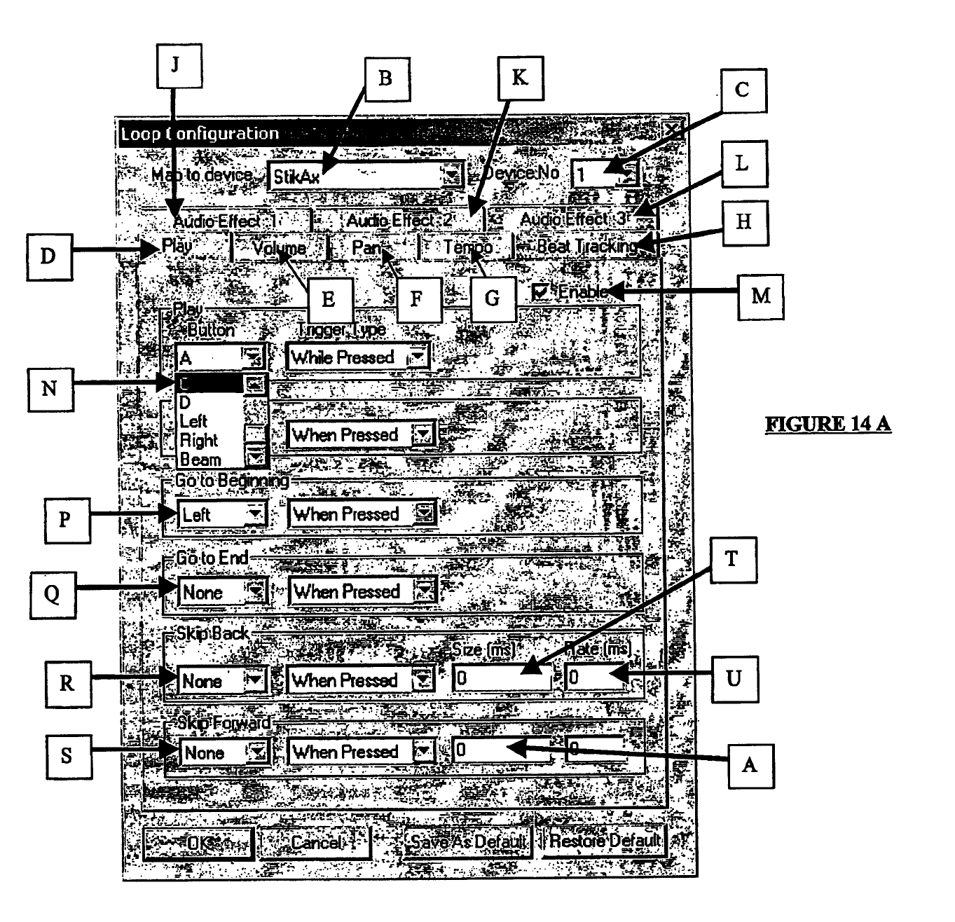

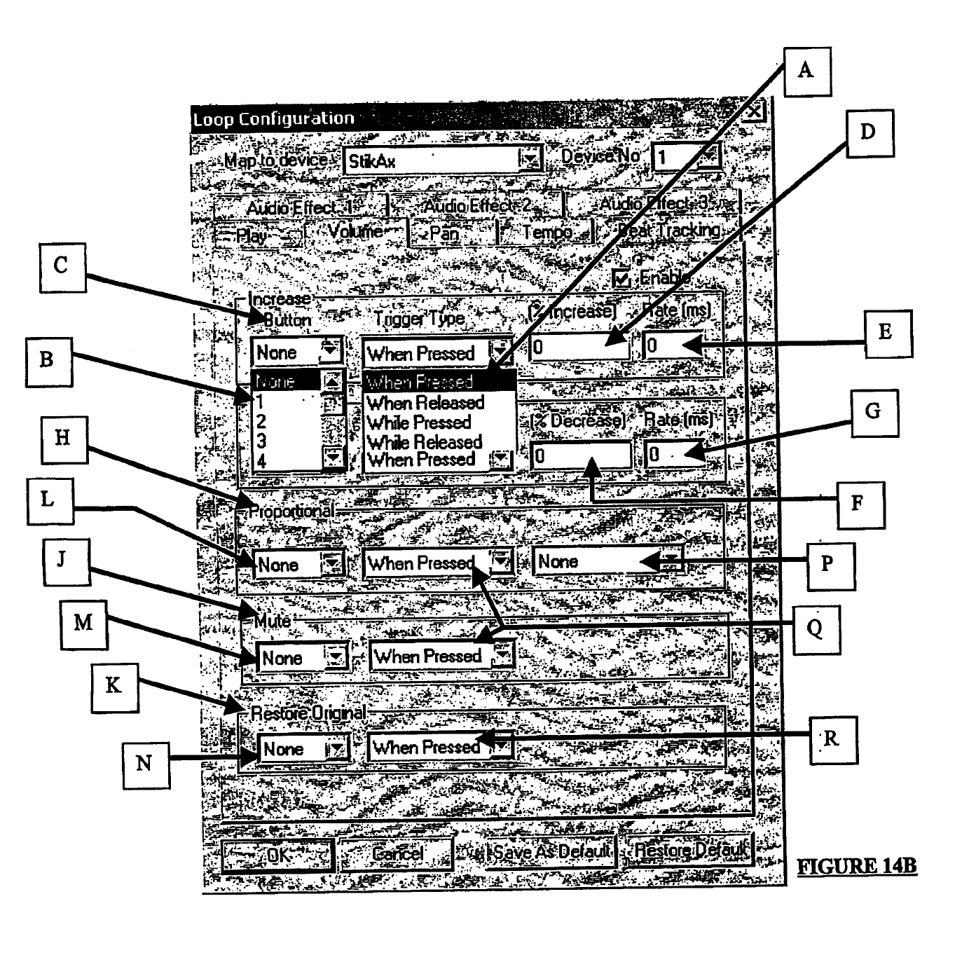

FIG. 14A shows a loop configuration display;

FIG. 14B shows a sub-display arising from to the FIG. 14A display;

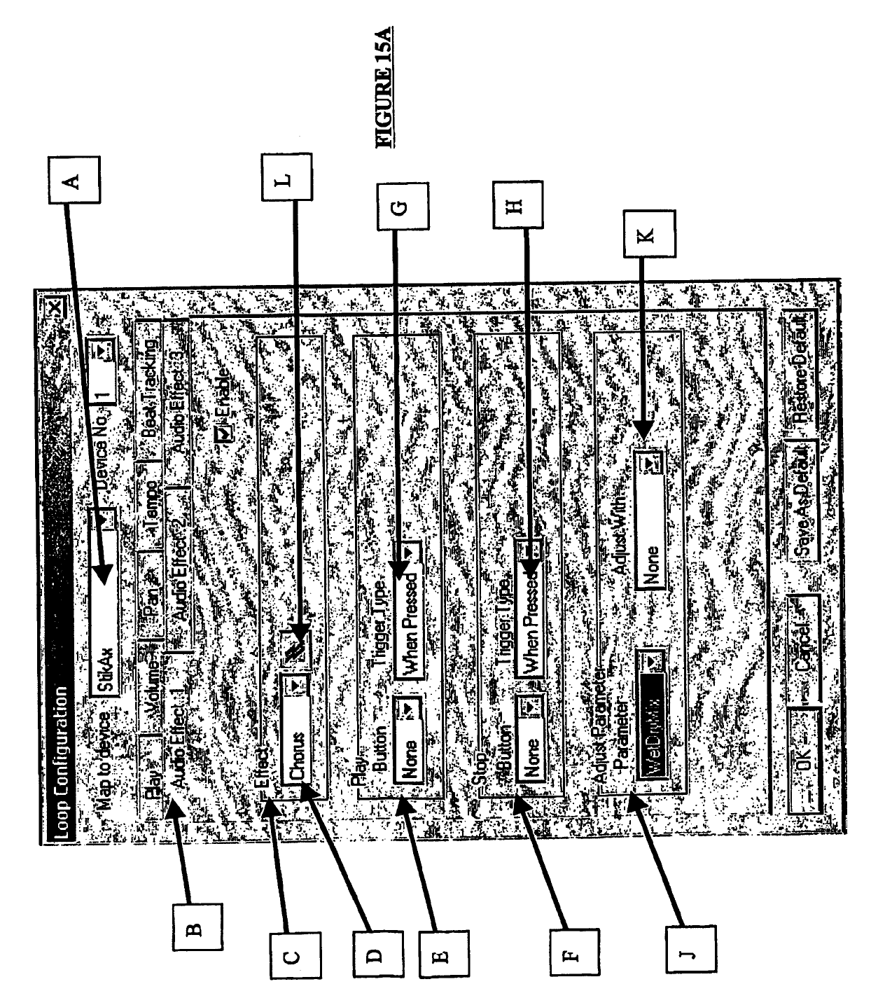

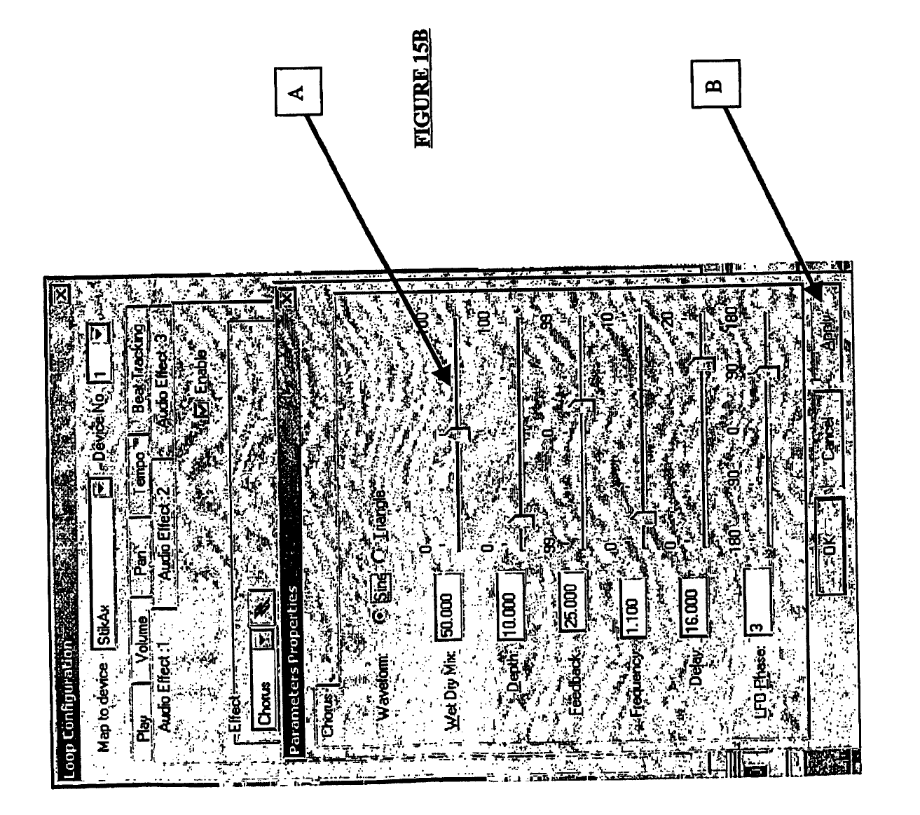

FIG. 15A shows the selection of a ‘chorus’ effect;

FIGS. 15B, 16A, 16B, 17A, and 17 show sub-displays arising from the FIG. 15A display;

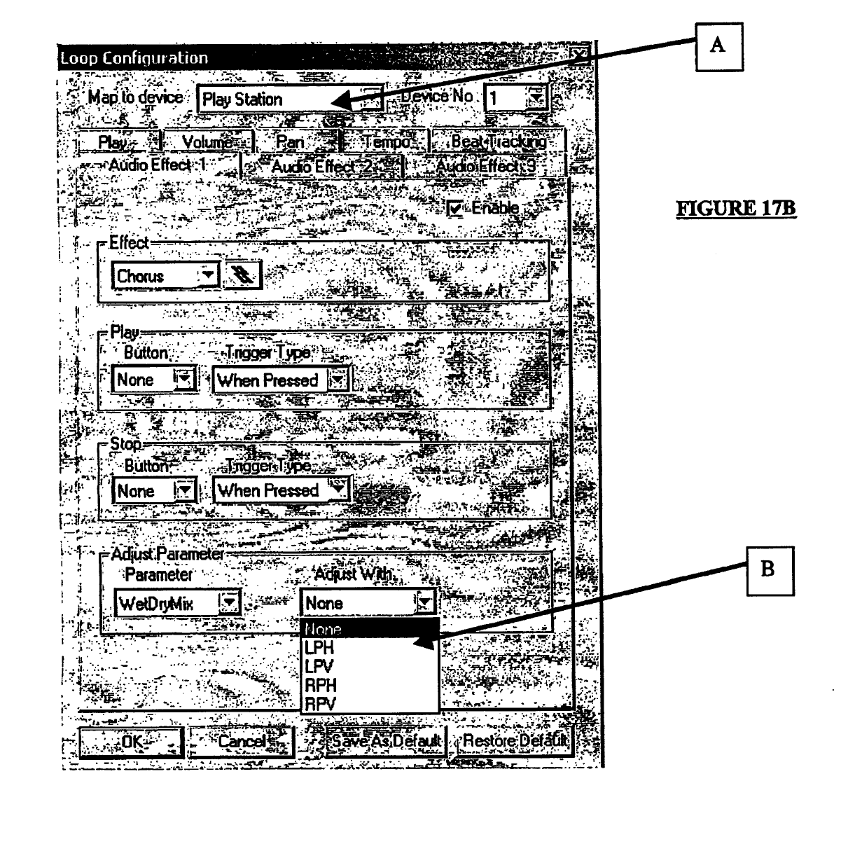

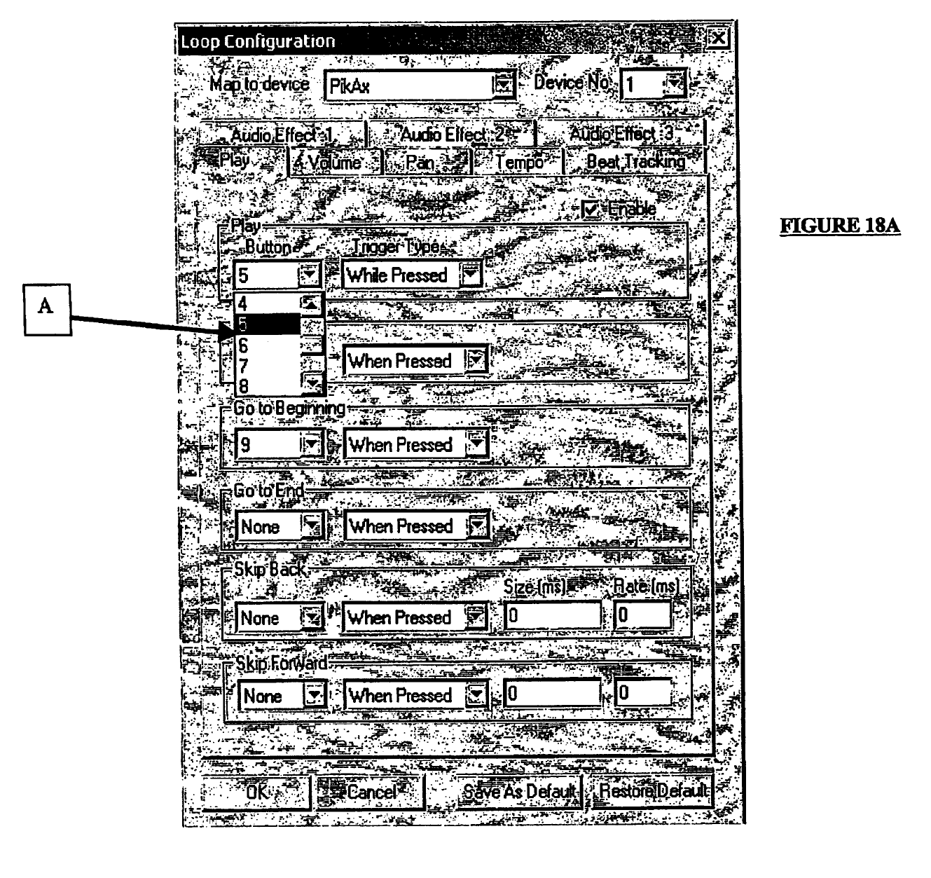

FIGS. 18A and 18B show the assignment of control members or different devices;

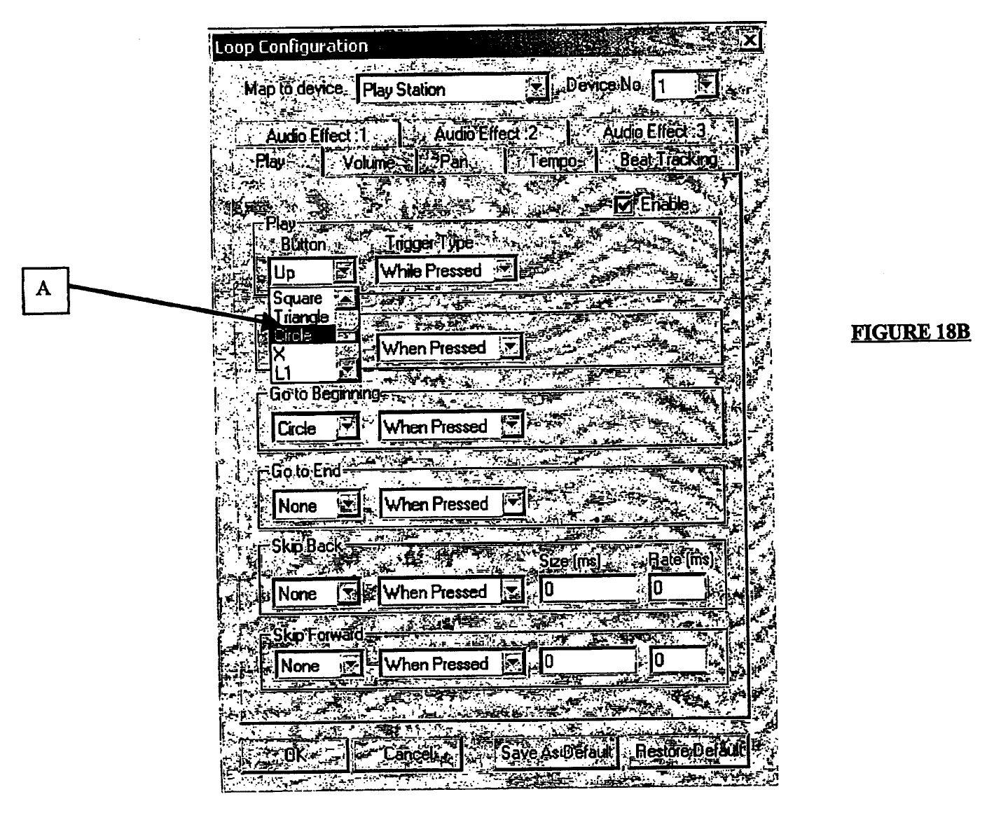

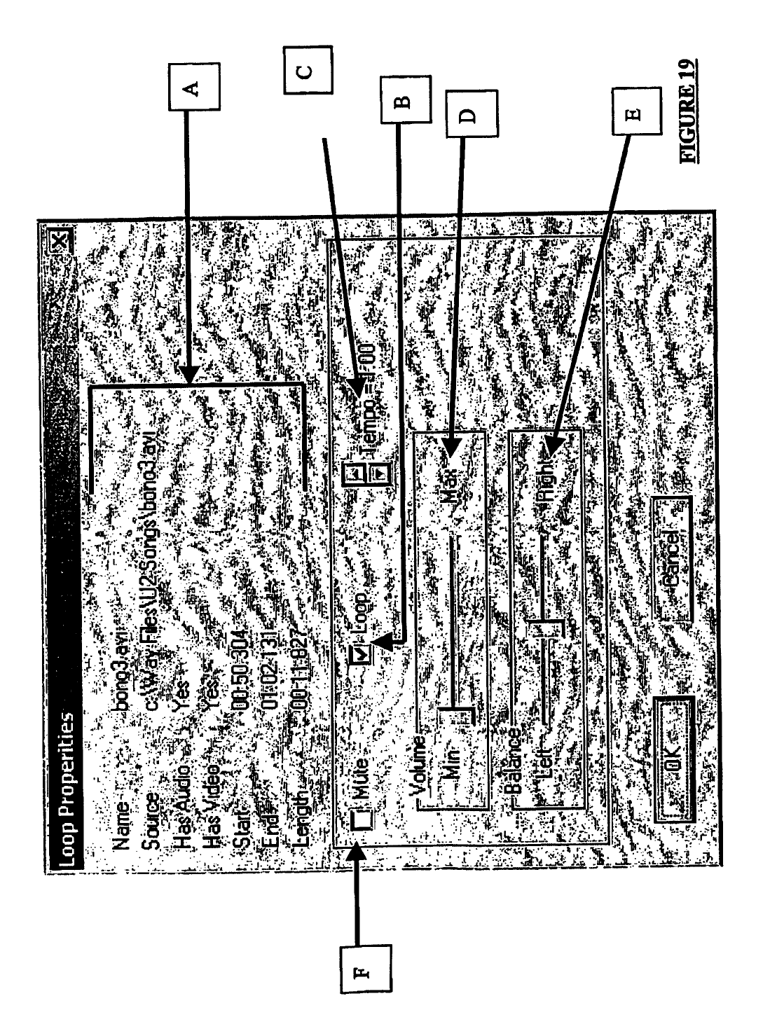

FIG. 19 shows a loop repository;

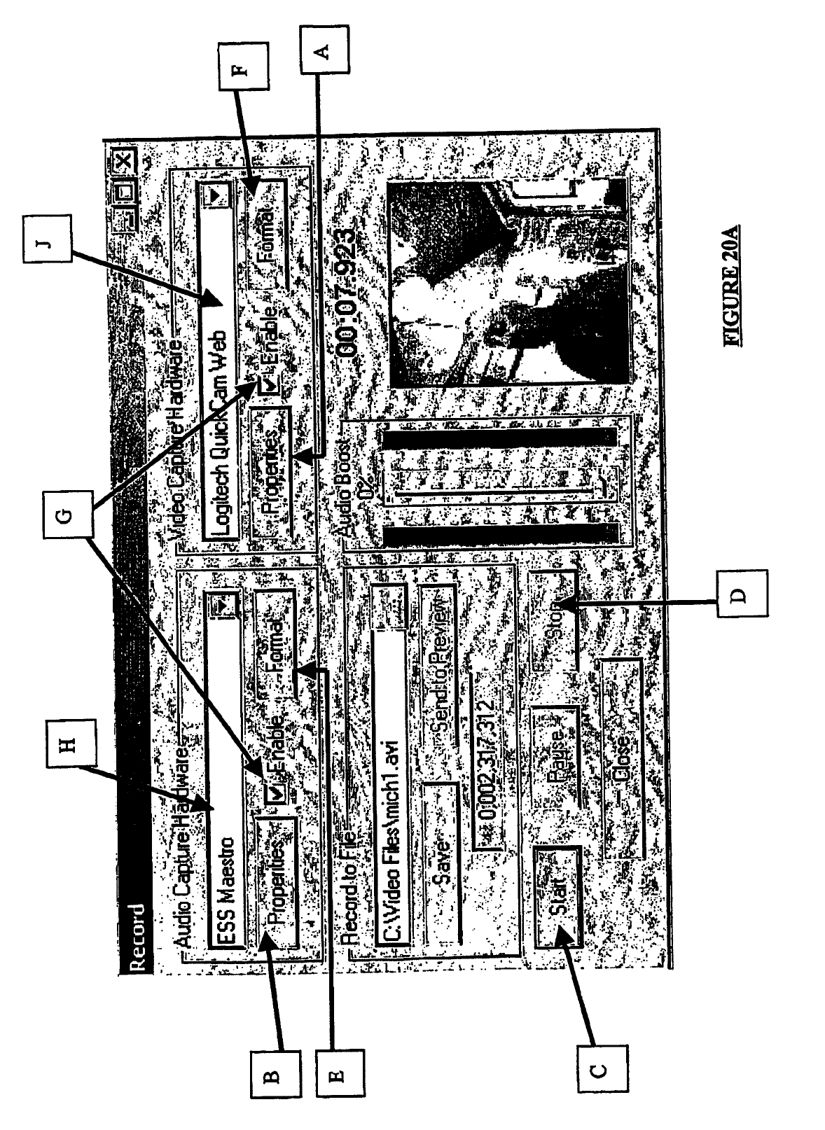

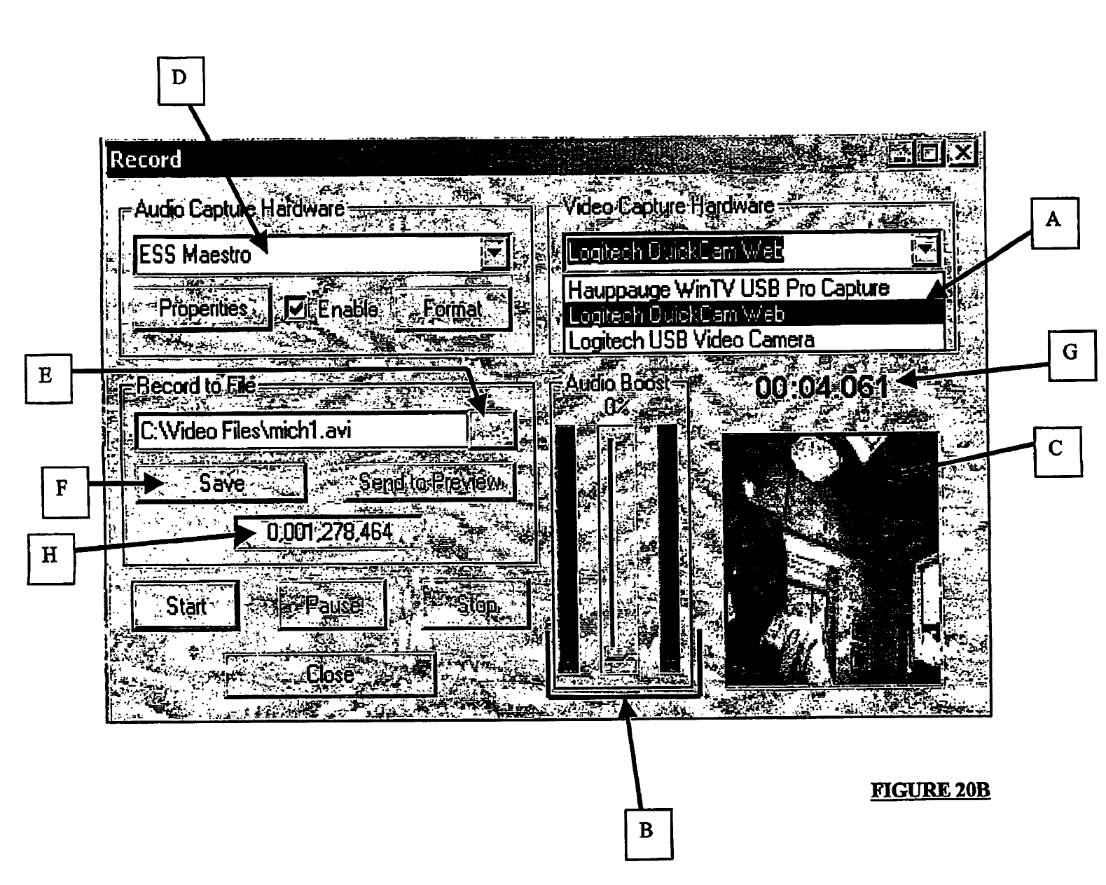

FIGS. 20A and 20B shows details of the selection of video capture hardware devices;

FIG. 20 shows the selection of video capture hardware devices;

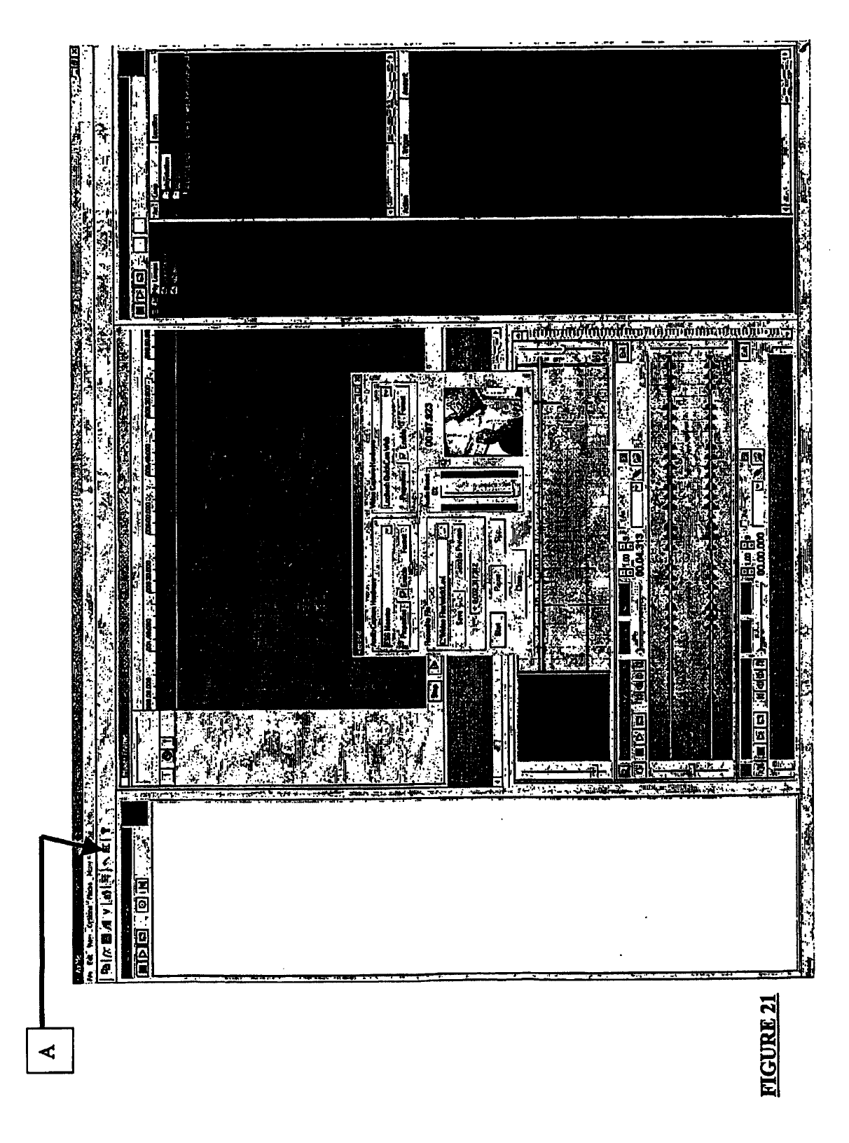

FIG. 21 further shows the loop repository;

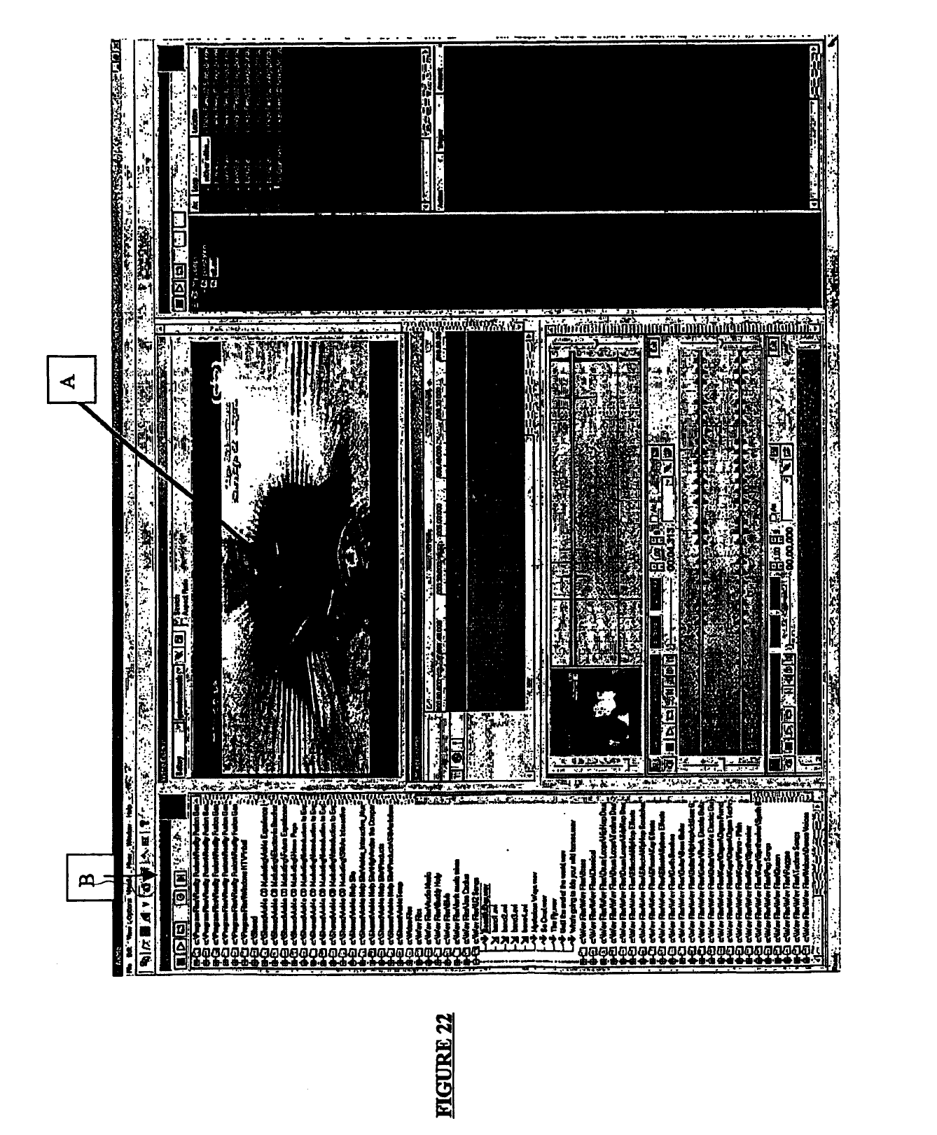

FIG. 22 shows the video component resulting from the intervention of the user of a control member; and

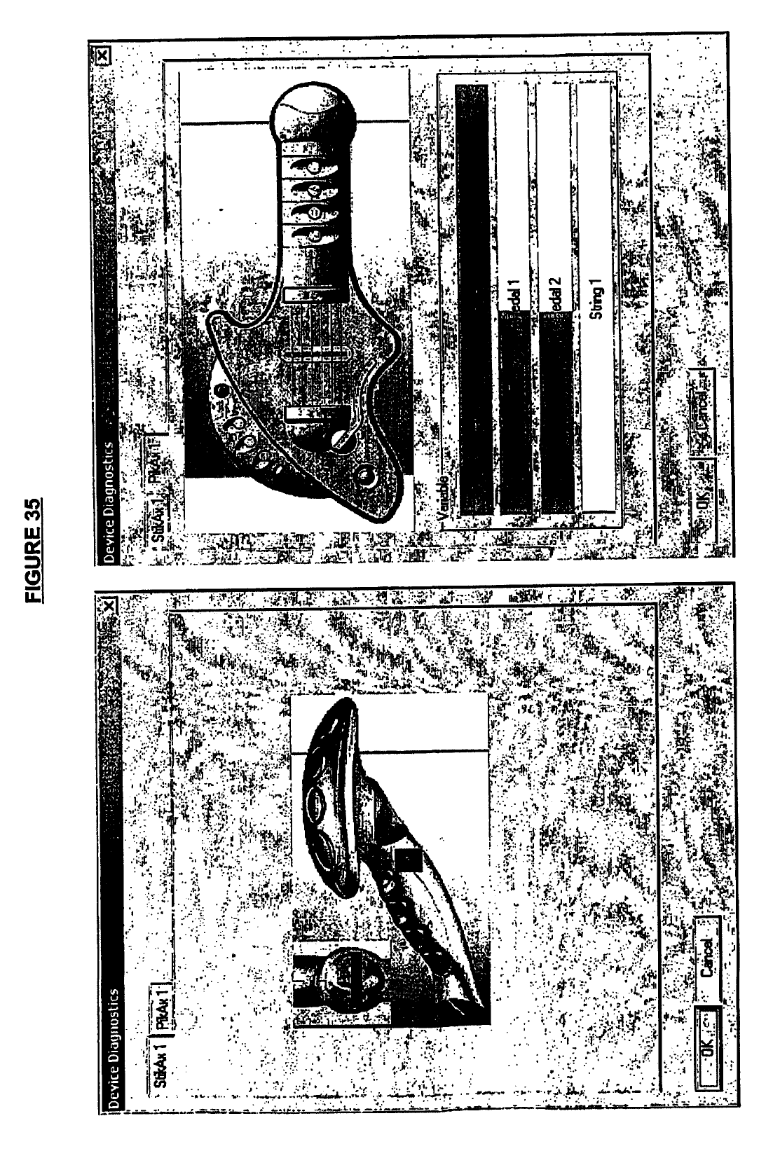

FIG. 23 shows two screen shots of the diagnostic features of the invention.

The present system comprises two main units: an operating device (interactive multimedia apparatus) and a control unit comprising a PC (personal computer) having the standard components including a processor unit, a mouse, a VDU, and a (visual display unit).

FIG. 1 shows four views of the physical structure of the operating device, and FIG. 2 shows its circuitry. The device has activation means operable by a user to generate electrical signals in response to the users' activation and selection.

The interactive multimedia apparatus (operating device) shown uses a USB (Universal Serial Bus) connection to the control unit. However, the connection from the interactive multimedia apparatus could be bluetooth, serial, parallel or any other connection method suitable for the purpose of data transfer. The processor contains RAM and ROM for program storage and processor workspace. The processor shown (U1) is from ST Microelectronics, but other manufacturers' products of similar functionality and specification could easily be substituted.

More generally, the control unit with which the application software will operate can be any personal computer, hand held computer, a music playing device with processing power, a mobile phone device particularly a 2.5 G or 3 G mobile telephone where an audio output is available), a personal digital organiser, a games console, a set top box device or any device with the necessary processing power to run the application program and has a visual display unit and the means to convert digital audio to analogue sound output. The control unit must have storage device space to hold riffs, loops, beats, one shots, etc. and memory space with sufficient working space to run the application satisfactorily. It is obvious that some devices will have limited processor power and RAM and ROM. In the case where limited processing power and memory space are available, the application will be limited to the lesser number of tracks which can be mixed and the range of control and effects which can be applied.

FIG. 10 shows an integrated MP3 player/mixer combination, where the dynamic mixing control members and the operating device are integrated in the housing and form a single composite piece. The application software is ported to this device, which allows the user to enjoy the complete mixing experience in a mobile environment.

Further forms of control unit are as follows:
A foot operated pedal-button apparatus.
A dance-mat where the mat includes switches placed within or under coloured segments of the mat or platform and the switches are activated by the pressure of the foot.
An automobile type steering wheel where the control members are placed around the steering wheel area.
   In all these cases, the control members are assigned, configured, and operate in a similar way to the control members referred to earlier. The system can also use voice activation references as the substitute for the mechanical activated control members.

The interactive multimedia device (FIG. 2) is a USB low speed (1.5 Mhz) bus powered device. It is connected to the PC via a 3 m 4 core screened cable. It receives its +5 volts power from the PC via a USB connector CN1. The CPU clock is set by a 24 Mhz crystal (A). When power is first applied, the CPU will be reset by the capacitors resistor combination C2, R2 and C3.

The device has a processor U1, eleven push-button switch control members SW1-SW11, an opto-coupled rotatable control member SW12, an output USB chip U2, a 24 MHz crystal A, a plurality of resistors and capacitors, and an LED. The central control unit of the multimedia apparatus U1 contains firmware, which detects the activation of the control members S1-S12 by the users, converts the control members' activations into electrical signals, which are sent to the control unit (PC or other programmable device) for processing by its software to perform the function assigned to the control member by the user using the software packages' functions described hereafter.

As discussed below, the set-up of the interactive multimedia apparatus control members is configured to suit the user's preferences. The rotatable control member can provide unique mixing effects on any track, loop, beat, riff, one shots, WAV, MP3, WMA etc. The rotatable control member can apply a scratch effect, back-play, replay, volume control adjustment, pan control, repeat etc. All control parameters and effects are assignable to any control member.

All USB devices must support suspend mode, which enables the device to enter a low power mode if no activity is detected for more than 3 ms. When the device is in suspend mode it must draw less than 500 μA. CPU Ports A and C are configured as outputs when entering suspend mode because as inputs each pin of ports A and C will draw 50 μA due to the internal pull-up resistors on these ports. CPU Port B does not contain any internal pull-up resistors, but external pull-up resistors are implemented in hardware at the opto-coupler photo transistor outputs. Thus these port B CPU pins should be configured as outputs and 5 V applied before entering Suspend mode.

During suspend mode the internal CPU oscillator is turned off. In this state the CPU will not be able to detect key presses or wheel movement. Thus suspend mode must be exited periodically to check if a button has been pressed or the wheel has been moved. Any bus activity will keep the device out of the suspend state.

The system can be woken up from suspend mode by switching the bus state to the resume state, by normal bus activity, by signalling a reset or by an external interrupt. The purpose of resistor R1 and capacitor C1 is to periodically awaken the CPU during suspend mode. Capacitor C1, which is connected to the PB5 external interrupt pin of the CPU, will charge via resistor R1 when in Suspend mode. C1. As soon as the capacitor voltage reaches the low to high trigger, the CPU is woken up or excited and checks if the wheel has moved or a button pressed (the system performs a remote Wake-up sequence). If nothing has happened, the system discharges the capacitor and re-enters suspend mode.

The R1.C1 time period sets the average current drawn by the product. The average current must be less than 500 uA to be USB compliant. With R1=1 MO and C=0.33 μF, the suspend period time will be 306 mS. (The formula for calculating a different R1.C1 time constant is: Average current drawn by the product={I max×800 μS+(250 μA×[period−800 μS])}/period. Imax is the current the product draws when fully active.) The average current should be selected to be 450 μA and the period calculated.

The PC includes a suite of software, which provides inter alia:
Driver software to interface with the interactive multimedia apparatus;
Software to interpret the electrical signals generated as a result of the users activation actions of the control members;
Mixing and editing software to allow users create controls, modify and adjust the components of their mix and the overall mix composition parameter during the mixing cycle by the operation of the interactive multimedia apparatus control members;
Configuration and assignment of the control members for differing functionality, controls and effects;
Configuration and assignment of a plurality of similar or dissimilar interactive multimedia apparatus; and
Mixing and editing software to allow users to configure, define and place their loops, riffs, beats, one shots, video-clips, microphone inputs etc. in tracks along the time axis ruler to be mixed at that time in the mixing cycle.

The user, by the activation of a control member on the interactive multimedia apparatus, can trigger a segment of a waveform component and dynamically mix that segment during the mix cycle, thereby avoiding the tedium involved in a manual editing process.

The system allows users to record all the controls, parameters and special effects details of the composite mix including the dynamically applied controls, parameters and effects initiated by the activation of the control members of the interactive multimedia device, which have been affected during the mix cycle. Moreover, the system provides the user with a visual representation in the form of a pictogram of each track in the mix displayed on a visual display unit and the exact position in time that the intervention occurred in the mix cycle, with highlighted blocks which show where additional, deletion or modifications, control changes, parameter changes and/or special effects have been applied as a result of the user's intervention by the activation of a control member of the interactive multimedia device. The representation of the pictogram represented on the visual display unit will also illustrate the control changes, parameter changes and special effects applied to the composite mix characteristics with the exact position in time where these events occurred.

There are many digital mixing and editing software packages available today and many of the features for manually operated mixing and editing included in this application software package are to be found in packages available to the public. In the present system, the user, by the operation of the control members of the interactive multimedia apparatus, can dynamically change the characteristics, parameters and effects of individual tracks or the characteristics, parameters or effects of the composite mix in real time during the course of the mixing cycle. The software allows for the assignment of effects and control parameters to the individual control members of a single interactive multimedia apparatus or a plurality of apparatus, interprets the action performed by the user's activation of the control members, and performs the function assigned to the control member or members within the mixing cycle in real time.

The application interface visual display areas and the control member assignment process will now be described, to demonstrate the associations between the software and apparatus set up, configuration, and assignment of parameters.

FIG. 3 shows the basic screen layout with some elements of the status bar B shown at the top. Track control panels C are shown for two tracks. The envelope windows A, which display the waveform of the loop, riff, beat, one shot etc. are shown for both tracks.

FIG. 4 illustrates the standard track controls within the track control-panel C. These include Stop (D), Play (E), Loop (F), Load (G), Effects (H), Tempo adjustment display (J), Mute (K), Volume (L), Pan (M), Time-marker (N), Progress-marker (P), Title-bar (Q), Waveform Resolution adjustment (R), Interactive multimedia apparatus control (S), Interactive multimedia apparatus configuration (T), and Track length (V).

The present system can be used in conjunction with video-files, AVI files, and other video media file formats. The user can load a video media file from the load Icon G shown in FIG. 4. The user can add a sound mix to the video media file by using any or all of the features and functions covered in this invention. Many users will import files from their digital cameras and add a sound track of their own creation. The present system empowers users to enjoy a fully interactive and creative experience.

FIG. 5 shows a box S which, when selected, will assign controls to the interactive multimedia apparatus for the selected tracks. When this box S selected, the activation of the track controls, parameters, effects configuration, and track selection are assigned to selected control members of the interactive multimedia apparatus, as described below.

FIG. 5 also illustrates an icon T which, when selected, will present to the user assignment set-up screens for the control members of the interactive multimedia apparatus as described below.

FIG. 6 shows the apparatus configuration screen, which will appear when icon T (FIG. 5) is selected. The user will select the desired apparatus to be configured from a choice of options presented. The physical representation 10 of the apparatus will be presented to the user with the control members clearly identified and labelled. A window 4 shows the track numbers associated with the mix and also includes a composite track identifier.

The user can select a track from the window 4, and then select controls from the selection windows 1, 2 and 3, which are only shown as a limited number of examples and would include inter alia all the controls shown in the track control panel in FIG. 4. Each of the controls in the configuration panel of FIG. 6 has individual parameters ranges assignable by the user. For example, the user may select Volume 1 to be adjustable dynamically by a control member. The application will allow the user to pre-determine a maximum or minimum threshold or allow a graduation in pre-defined steps by any selected control member or by the rotatable control member. Similarly with the tempo selection 2 the user may select a fine or coarse adjustment to be applied by the application to the selected track or to the composite mix when the associated control member is activated. If the user desires to add some effects to a track or to the composite mix, the user can select window 3, which will present a menu of effect options 7, from which to select. The effect selected will be applied by the application to the track when the associated control member is activated.

The user must then assign the selected controls and effects to a control member of their choice. A button assignment 8 will display a selection of the control members available on the selected interactive multimedia apparatus. When the user makes the button assignment choice, the attributes selected for controls, parameters and effects will be applied to the individual track or group of tracks or to the composite mix by the application program detecting the activation of this control member.

The parameters assigned to the control members are shown to the user at 9. The user selects the control member A-K, as shown in the visual indicator 10 of the physical device, and the software will display the controls, parameters and effects assigned to that control member.

FIG. 7 shows a trigger type sub-menu which can be selected from the screen shown in FIG. 6. The user can select the method of response to the activation of the control members. For convenience, two options are shown, allowing the user to request, by selecting buttons 5 or 6, that the control and effects be triggered on the button press or on button release. In practice there will be a range of trigger options, including inter alia; sustain, play from start, stop, scratch, replay, repeat etc.

FIG. 9 displays on the left-hand side A of the screen a scan display view window, displays directories, folders, and content files resulting from the software scanning the storage devices for user selected media types. The user may wish to display a listing of all the WAV, MP3, AVI etc. files or for WAV files only on the storage devices for ease of loading and selection. The scan process is initiated by selection of the icon D on the toolbar.

The scanning process of the storage areas for the user selected media type can be carried out in real time. The user, by selection of any of the icons E, will be presented with the individual media component contained in their folders and/or directories. The user can drag the desired media component and place it in the waveform display area F. This facility interrogates the storage for a user requested media type in real time, thus eliminating a difficult, tedious and sometimes impossible task of finding the desired media content using conventional search methods. The facility to scan the storage devices for the desired content file and the facility to drag the selected content file into the waveform display area are critically important for the non-professional users of digital mixing and editing software packages.

Editing can be a tedious process for the user working with the currently available digital mixing and editing packages. The user may desire to use a small segment of a loop, riff, beat, one shot etc. in the mix. The user must mark the areas to be cut and then open a new track and insert the cut in a pre-defined position on the time axis ruler or place it directly in the mix composition in selected positions along the time axis ruler. It is very difficult for the users to anticipate the sound effect results produced by the combination of the mixed tracks at any point in the mixing cycle.

With the present interactive multimedia apparatus, the user can intervene in the mixing cycle to apply a sound, beat, riff, loop etc. or a segment of a loop, riff or beat of video media at any time that they feel that their intervention would provide a complimentary and enhancing contribution to the mix. The interactive multimedia apparatus allows the user to select and mark a segment of a waveform component and dynamically mix that segment during the mix cycle, thereby avoiding the tedium involved in a manual cut, paste and copy. Examples of conventional mixing and editing and the effect that this invention will provide with the dynamic mixing and editing processes are explained further in the application with reference to FIGS. 8-8F.

The present system allows users to intervene during the mixing cycle by the activation of the control members of the interactive multimedia apparatus. The parameters, controls and effects assigned to the detected control member will be applied to the mix by the application software in real time. As the user intervention is dynamic and can occur at any time during the mix cycle, it is imperative that the intervention for controls, parameters or effects triggered by the activation of the control member are recorded with all the parameters applied and captured at the time that they were applied and also for the duration of their application. The software application will store the parameters, effects and controls resulting from the activation of the control members and will present them to the user on the visual display unit in block waveform images as individual track components in their correct position along the time axis ruler with the other fixed positioned tracks positioned by the user in the pre-mixing set-up. The user will therefore be presented with a visual image of the mix of tracks including the dynamically created component to allow for additional editing, mixing, effects etc.

The record select icon is shown as example at B in FIG. 9. Selection of Icon B will initiate the recording of the composite mix sounds and the recording of the characteristics, effects, parameters, trigger time and duration of activation etc for future visual presentation in the track waveform layout template. Icon C shows the play button for the commencement of the mixing cycle for the generation of the composite mix. Button Icons B and C are shown for examples only, as many other global controls are included; volume, tempo, effects, pan, pitch etc.

FIGS. 8, 8A, 8B, 8C, 8D, 8E, and 8F are an abridged series of diagrams which display visual representations of the dynamic mixing, editing and the recorded visual representations as described above.

FIG. 8 shows an example of a conventional manual mixing and editing process. The example shows an abridged series of track representations and a small section in time within the mixing cycle. The user selects the content they desire to be assigned to each track and can position the content block in the desired position on the time axis ruler G. In this example, the user has selected and configured 3 content tracks shown in FIG. 8, labels 1, 2 and 3. The user can manually pre-assign effects, controls and parameters of their choice to the content within each track and at any time along the time axis ruler in the pre-mix selection. The effects applied by the user to the track components will be implemented by the software when the play-bar reaches that point on the time axis ruler during the mixing cycle.

The user may then wish to add (Edit) a segment of a loop to the mix at differing times during the mixing cycle. The user wishes to use a segment B, FIG. 8A, from the selected loop. The user then selects and marks the start CI of the component (FIG. 8B) and either by dragging the cursor or through menu selection, marks the end CII of the component. The user must then insert the selected block C into the mix in a selected position on the time axis ruler, either as a new track layout or within an existing track layout. In this example, the edited blocks C are shown as being manually inserted along the time axis ruler within a new track 4.

In this manual mixing and editing process, the user cannot accurately anticipate the resulting sound effects achievable by the pre-assignment of effect characteristics to a track or to a track component in advance of the mixing cycle occurring. The user must also try to anticipate the sound effect generated by the introduction or placement of an edited component in advance of the mixing cycle occurring. In the conventional manual mixing and editing packages, the user is either totally restricted or has severe restrictions placed on their capacity to intervene dynamically during the mixing cycle to add effects or change parameters at the track level.

The present interactive multimedia apparatus will provide a dynamic experience for the user and will provide a simpler and more useful interface when compared with conventional digital mixing and editing offerings. An example of the operation of the present system will now be given, using the same parameters as in the example of the manual system explained above, to allow the user to dynamically intervene to change any controls, parameters or effects to individual tracks or to the composite mix's controls, parameters or effects.

As indicated in FIG. 8D, the user selects and loads the same three content tracks 1, 2, and 3 of FIG. 8, and also at this time loads the track as indicated in FIG. 8A, which was used to edit the selected waveform block used in the previous example. The user wishes to dynamically mix and edit the tracks to provide the sound composition of their choice.

The user will choose and then select and activate the button E (FIG. 8D) which transfers control of the assigned track controls, parameters and effects to the interactive multimedia apparatus. (The selection and assignment of controls, parameters and effects have been described above.) Selecting and activating the button H will apply the effects, parameters, and controls assigned by the user to the control member or members chosen by the user from the selection menu as described earlier. The user can then select the trigger type of activation desired for the response to the activation of the control member.

The user wishes to select a component B (FIG. 8A) from the loop, and more specifically the component area C. The user marks the start CI of the block (FIG. 8D) and drags the cursor or marks it at position CII for the end of the block. The loop component block C will be the component that is triggered by the activation of the assigned control member during the mixing cycle. The user can also assign controls, parameters and effects assigned to the loop component C to be applied by the software during the mixing cycle.

When the user starts the mix cycle, by activating the assigned control member on the Interactive Multimedia Apparatus or by mouse click or key depression of the play button on the user interface screen, a play-bar I (FIG. 8E) will move across all the tracks' waveform envelopes, synchronised across each track. FIG. 8E shows four tracks being mixed in the composition. At any time during the mixing cycle, the user can activate the control members of their choice on the interactive multimedia apparatus to apply the pre-assigned controls, parameters, and effects to the individual tracks or the composite mix. In this example controls, parameters and effects have been applied dynamically to all the tracks 1, 2, 3, and 4 by the activation of the associated control members.

A unique component of the present system is the ability to capture and store in real time the controls, parameters, and effects which have been applied to the mix by the activation of the control members in response to the user's activation of the control members of the interactive multimedia apparatus and to be able to recall and represent the resulting composite mix in pictogram form for visual examination, re-mixing or re-editing. The pictogram shows the correct positions of the waveform blocks along the time axis as they were mixed in the mix cycle and provides a marked, shaded, or coloured area highlighting the modified blocks with associated flag, which when selected will present to the user the controls, parameters, and effects applied to that modified waveform block by the user's dynamic intervention during the mixing cycle.

FIG. 8F shows the pictogram, which displays in visual form a record of the mix waveform components for each track in their play position along the time axis ruler and the highlighted modified blocks with a flag to indicate that a control, parameter or effect has been applied to that portion of the waveform. In the first track 1, the blocks V, X and Y have had some effects applied to them by the user activating control members during that time in the mix cycle. If the user clicks on the flags within the area of the highlighted blocks, the software will display a list of the controls, parameters, and effects which have been applied to the modified waveform block and an enlarged display to show the modification that has been effected. Similarly for the second track 2, the block U has had a control, parameter, or effect applied by the activation of the associated control member. The block W of the second track 2 has no waveform display, which indicates that the user had activated a control member at that point in the mix cycle which applied a mute control to that track. The third track 3 shows highlighted and flagged block Q and R, which indicates that controls, parameters, or effects have been applied at that time in the mixing cycle. The fourth track 4 shows four highlighted blocks C, which shows that the selected waveform block (C, FIG. 8D) was triggered at that time along the time axis ruler G, where the user activated the associated control member. The user also has an audio recording of the composite mix, which can be replayed through their audio reproduction system.

The user can re-edit or re-mix the recorded composite by manually repositioning the blocks within the mix pictogram representation or by editing or re-assigning controls, parameters or effects to any of the highlighted or flagged blocks. The software package of the present system allows the user to manually apply controls, parameters and effects to any tracks, waveforms, loops, riffs, beats, one shots, WAVs, MP3 files, MPEG files, Video formats, AVIs etc.

Additionally the software in this system will sustain an activity log of all user activity, whether the user is playing their CD music source, looping a piece of audio or video in their editing window, previewing a video or audio source in the preview window, applying an effect to a data source, triggering a loop in the loop repository etc. or just messing about with different video and audio sources or data capture devices. The user can at any time render/mix the content of the activity log to produce a composite of the audio and video events which have occurred. They can then re-edit or save this for distribution to friends in any known media format or be transmitted by email.

The activity log can be audio only, video only, or a composite of audio and video. The activity log will also show the timing of the event occurrence along the time axis ruler and will also identify the control, parameters, and effects that have been applied to each piece of digital data.

It is the ability to dynamically intervene in the mixing and editing cycle and to empower the user in real time to apply changes to controls, parameters, and effects, and to be able to capture and record and replay and represent in a visually interpretable format the mix components and then to preset the changes and modifications of the composite mix at the exact time that they occurred in the mix cycle, which makes the present system unique.

FIGS. 6 and 7 show a methodology for the assignment of parameters, controls, and effects to and the assignment and selection of the triggering control members for loops, riffs, beats, one-shots, Avi files, Mpeg files, video files etc. This methodology may be modified in various ways which will now be described.

FIG. 11 shows a loop repository/loop store area where all the content which is to be triggered by the activation of the control members will be stored and retained. The loop content may be a wav, WMA, Avi, Mpeg file or any other known media format. Loops can be combined in separate folders for easy content management or for group assignment to different triggering devices. Each folder or file can be activated or deactivated by the selection or de-selection of a flag B.

Data for the loop repository can be obtained from user-owned CDs, the internet, TV channels, radio broadcast, web-cam, digital media camera etc. and placed directly into a folder in the loop repository. Users may wish to take a small section of sound, or sound and video and place it in the loop repository. The software provides a facility to cut and paste a section of sound, or sound and video, from a composition and drop that selection directly into the loop repository.

FIG. 12 shows two tracks of data; track B is a composite of video and sound, and track D is a sound only track. The waveform envelopes show the sound component only of the content. The user may wish to take a small component of the loop and use this as a triggered piece in a future mix. The user places their mouse in the position A(i) and drags it across to position A(ii) to mark the exact position within the loop that they wish to select. The user can then drag the marked shaded section and drop it into the loop repository E. The video clip A with its associated audio content in the selected section is thereby placed securely in the loop repository and available for the trigger selection and content assignment at a later date. A similar process of marking the position within the loop pertains for the sound loop D. The section C can be dragged directly into the loop repository at F.

The user can now assign controls and parameters etc. to the loops, so that they may activate them at the desired time in the mix with the associated assigned controls and effects they wish to apply to these loops. The ability of the software to allow users to assign controls and parameters to content stored within the loop repository and to then empower the user to trigger these controls and parameters to the composite controls and particularly to individual parameters of a control or an effect in real time, distinguishes the present system from any other mixing software and makes it unique.

FIG. 13 illustrates a process of assignment of controls, effects etc. to loop repository items. A media file loop A is contained in the loop repository. The user selects the media content loop, by a keyboard press, a double click of a mouse, voice activation, or any other convenient method. When the user selects the loop A, a configuration screen B will be presented to the user, leading to the screen shown in FIG. 14. This is a full screen layout of the loop configuration selection screen, with M showing a selection box to enable or disable the assignments associated with the selected loop.

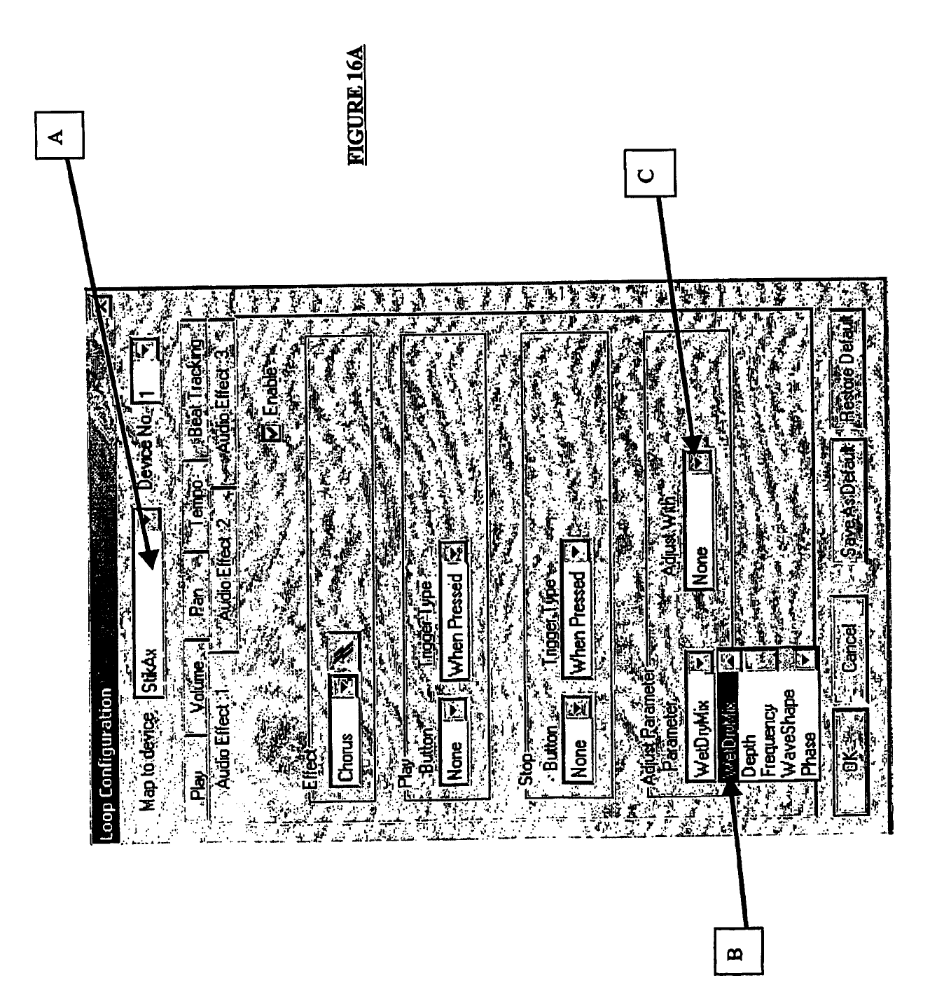

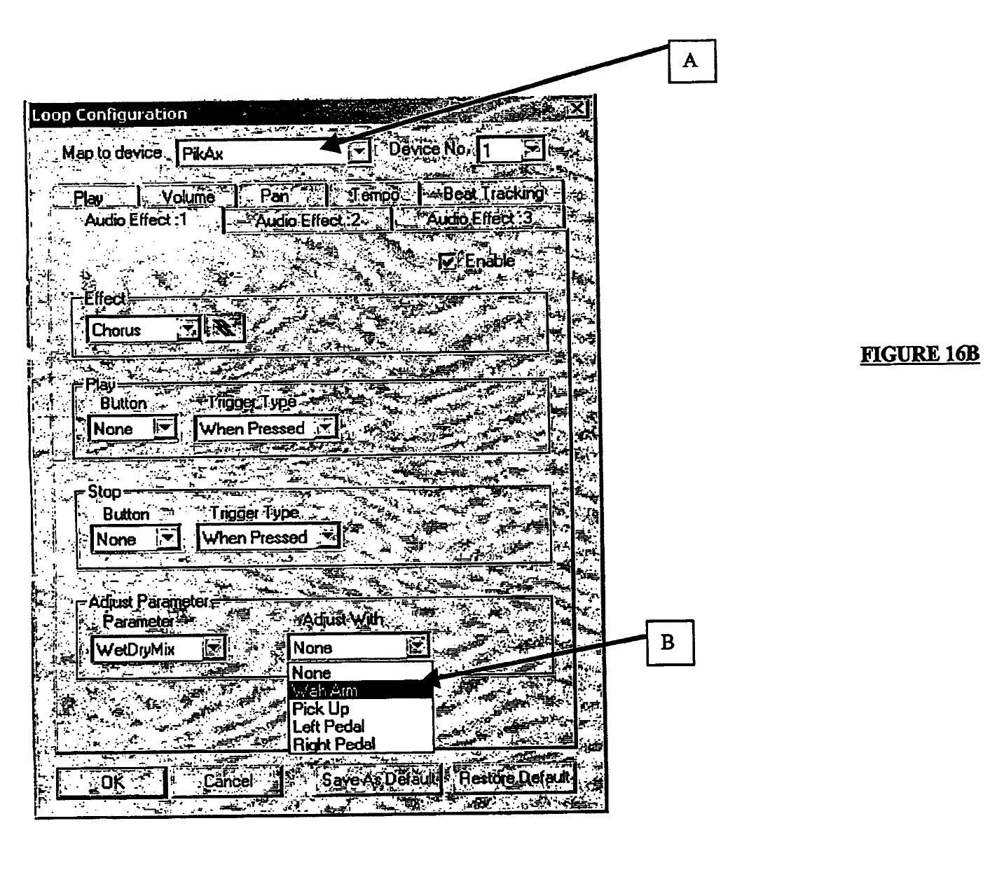

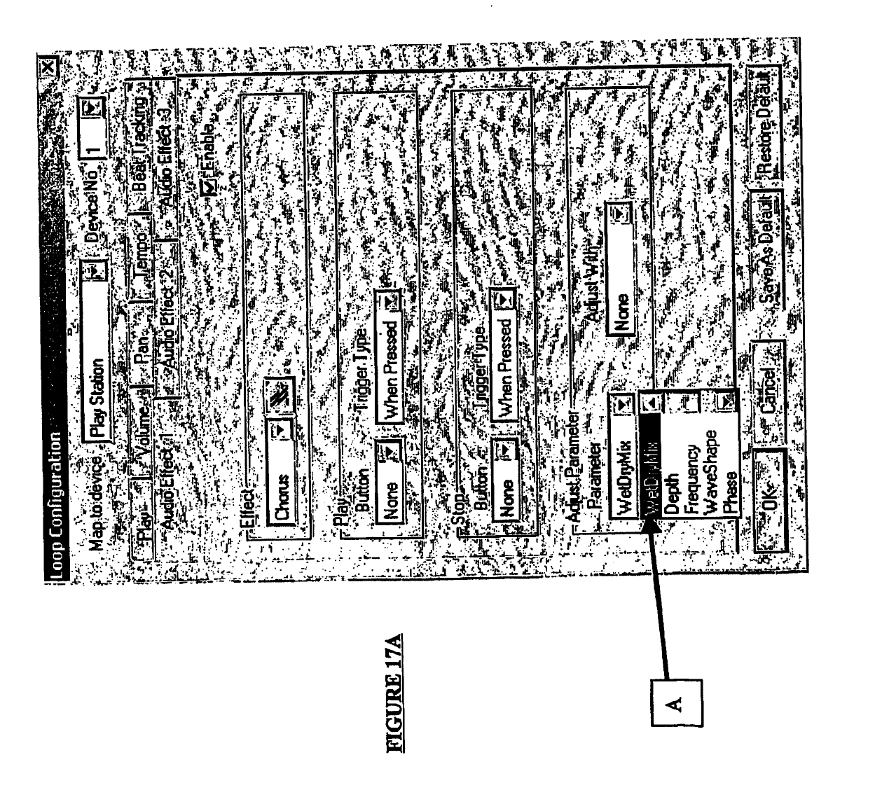

In FIG. 14A, B shows a device section window which allows the user to select the type of triggering device they wish to configure. There are a range of types of devices covered; for example, the device PikAx is chosen at A in FIG. 16B, and the device PlayStation controller is selected at A in FIG. 17B. The user can then select the device number C (FIG. 14A) to identify the device number from a plurality of similar devices. The user can decide whether to apply individual controls and/or effects from a menu, as for example shown in FIG. 14A: ‘play’ D, ‘volume’, ‘pan’ F, ‘tempo’ G, ‘beat tracking’ H, ‘audio effects 1’ J, ‘audio effects 2’ K, and ‘audio effects 3’ L.

FIG. 14A shows how the user might assign controls to the ‘Play’ function. N shows a window which when selected will present to the user a list of control members that may be selected as the trigger mechanism for the selected device type as shown at B. Control members for the selected devices as shown in FIGS. 16A, 16B, and 17B at A are presented to the user in the window N, if those device types are selected by the user. Similarly, associated control members for the selected device type are shown in all drop down menus for all the contents and effects selected by the user. In the ‘play’ assignment example N, the user selects the appropriate control member they wish to assign as their trigger mechanism.

When the user has selected the control member N, they must then select the trigger type. The trigger type means the state that the control member is in when the loop is to be triggered, shown for example purposes only by the menu B (FIG. 14B) with 4 states. The user may wish to trigger the loop dynamically when the control member is pressed, when released, while pressed, or while released. The user selects the preferred trigger state for the control member. When the user activates the selected control member N (FIG. 14A), the selected trigger type state A (FIG. 14B) will control how the loop will start to play.

The user can then proceed to continue their selection process by selecting a trigger type state to stop the selected loop. The user selects the stop window obscured by the drop down menu B (FIG. 14B). The control members for the selected device will be presented to the user in a similar fashion to those presented for the ‘play’ function trigger. The associated trigger type state menu will also be available to the user to select, as explained for the ‘play’ function. The user selects the appropriate control member and trigger type state for the ‘stop’ function. Additionally the user can also select in a similar fashion to the ‘play’ and ‘stop’ function, a facility P (FIG. 14A) to ‘go to the beginning’, ‘go to the end’ Q, ‘skip back’ R; or ‘skip forward’ S. The user has additional controls available to assign to the ‘skip back’ and ‘skip forward’ functions. For example, T is a window to allow the user to assign a time parameter setting for the ‘skip back’ and U is a setting which will allow the user to control the frequency at which the ‘skip back’ will occur. These two parameter settings adjustments T and U provide the user with great scope to modify and create new sound sensations during a mix.

For volume, pan, and tempo, the user is presented with a screen of controls similar to that shown in FIG. 14B. The user may wish to increase the volume or tempo of a selected loop type. The user will select the control they wish to adjust, for example the volume E (FIG. 14A) or tempo G. The user selects whether they want to increase (C, see FIG. 14B) or decrease the volume or tempo. The user selects the appropriate control member number from the drop down menu C of available control members for the selected device type. They then assign their preferred trigger type state from the menu (A, FIG. 14B). The user may then enter in the input field D a number to represent the percentage they wish to increase the volume or tempo by. The user can additionally enter a figure in the field E to control the rate in milliseconds that they want to apply this increase in volume or tempo when the associated control member is activated. Similarly the user may reduce the volume or tempo by selecting and assigning controls and parameters in the appropriate reduce field as shown at A, F, and G. Some device types may provide analogue controls similar to an adjustable variable resistor. Analogue controls or proportional adjustments may be similar to those found on Sony PlayStation controllers, foot pedals, or wah wah arms. H shows a selection option is shown for a proportional control member.

The user selects the appropriate control member from the appropriate list L for the selected devices as presented in the menu. The user then selects the trigger type state from the list Q. When the selected control member is activated in the selected trigger type state, the proportional adjustment parameter variations are then activated and the movements of the proportional control members will then apply the selected adjustments to the loops. B in FIG. 16B and A in FIG. 17B show some of the proportional control menu selection options.

For both the volume and tempo adjustments, the user can mute the selected loop by selecting the ‘mute’ option J (FIG. 14B) and assigning the appropriate control member M with the selected trigger type state Q. The user may wish to retrieve the original settings of the volume and tempo; this can be achieved by selecting the option K and assigning the control member N with the trigger type state R. For the pan function, the user is presented with a similar menu with a range of solution options for the left and right adjustment and controls.

The user may now wish to apply a special effects feature dynamically to a loop by the activation of a control member or a plurality of control members. The present system allows users not only to dynamically apply special effect parameters to a loop, but also to select, control, and adjust any individual or group of parameters which make up the separate components of that special effect generator.

For example, we will illustrate the assignment of a ‘chorus’ special effect which is to be dynamically selected, adjusted, and modified by the software resulting from the activation of one or a group of control members of a selected device type. The user selects ‘Audio Effect 1’ as shown at B in FIG. 15A. The user will then be presented with an effect selection drop down menu C. The user selects the chorus effect D as the desired effect they wish to apply.

FIG. 15B shows some of the parameter properties required to effect a ‘chorus’ special effect. The user sets the slider adjustments to achieve their desired effects. The user confirms the parameter properties at B; these properties will then be applied when the selected effect is activated. The user then assigns the control member activation for the assigned effect. The user selects the appropriate control member E (FIG. 15A) to activate the effect on the selected loop and its associated trigger state condition G. The user assigns the desired control member and associated trigger type state to stop the effect by selecting the appropriate fields F and H. The present system will, by this means, allow users to dynamically adjust any, all, or a group of parameters associated with a special effect across the full control range from 0-100 (FIG. 15B).

A user can select the parameter they wish to adjust by selecting from the drop down menu J (FIG. 15A). The user is presented with a menu of the individual parameters they may wish to adjust and they then select the control member C (FIG. 16A) they wish to assign to control the parameter adjustment; a short list of proportional control members for parameter adjustment is shown at B in FIG. 16B. When the user selects the effect to be triggered, the global effects parameter properties (FIG. 15B) are applied when the ‘play’ state is triggered. If the user additionally adjusts the assigned control member K in FIG. 15A, then the specifically assigned parameter J will be adjusted and applied to reflect the equivalent slider position movement in sympathy with the movements of the associated control member across its complete range of movement.

A menu of assignable parameters for the selected effects parameters for different device types is shown at B in FIG. 16A and A in FIG. 17A. A in FIG. 16B shows the effect selection for a device B with a wah arm and foot pedal controls. FIG. 17B shows some proportional controls B for a PlayStation controller device, and FIGS. 18A and 18B show an example of the assignment A of control members of a guitar-based device and a Sony PlayStation controller.

The user may wish to modify or adjust the properties of a loop in the loop repository. The user can right click on the selected loop in the loop repository and they will be presented with a screen as shown in FIG. 19. The user will be presented with details A of the file date shown. In this example there is both video and audio data. The user may wish to loop this file by loop control B when it is activated by a control member. The user may wish to change the tempo C, adjust the volume D, change the balance from left to right E or mute the loop F. The user can also cut and paste the loop configuration and assignment by right click on the selected loops. Additionally users can create folders, rename folders and loops, and delete loops and folders etc.

We have now entered the world of multimedia. There has been a proliferation of data peripherals such as digital cameras, digital video cameras, web cameras, set top boxes, USB and Firewire digital TV tuners etc. Users have great difficulty integrating their hardware and software from different vendors and suppliers and integrating them into an application that provides them with a composite editing and mixing solution. The software in the present system provides a single audio and video interface for users to capture data from a plurality of data capture devices and integrate the data into a fully interactive and dynamic mixing solution.

As an example to illustrate this, the user selects ‘record’ icon A on the top of the main screen shown in FIG. 21. The user in then presented with a screen shown in FIG. 20A. The user can enable either the audio or video record functions by selecting the option G. The user may then select either the audio or video capture device type from a menu H for audio devices or J for video capture devices. Additionally the user can select and adjust the properties and format B and E of the audio capture device and the video capture device properties or format A and F.

FIG. 20B shows at A three video capture hardware devices. The user may wish to boost the audio signal, as the built-in microphones of some PCs provide a very low level of signal response. The user can boost the volume of the audio signal by moving the fader B. When the user has selected their audio, or video source, or both the audio and video sources and have set the properties and format they desire, they can start the recording session by selecting “Start” C. When the user has completed the recording cycle, they can stop the session by pressing the ‘stop’ button D. The user must then select the file name E and then save the file by selecting the ‘Save’ button F. A small screen area C is reserved to show the user the captured images and allow for adjustment of the video capture properties and format. A timer G is shown to indicate the elapsed time to that point in the recording session. A meter FIG. 20B Label H show the file size at that point in the recording cycle. The user can take the capture file data which can be audio only, video only, or a composite of both, and place them in the loop repository for dynamic triggering, or edit them to produce smaller selected components, with or without effects, which can then be transferred to the loop repository or to the static mixing palette.

The present system provides a complete, easy to use, fully integrated dynamic mixing and editing solution for audio and video content. FIG. 22 shows a screen layout showing in the window area A the video component resulting from the dynamic intervention of a control member assigned to a loop in the loop repository. The mix resulting from the activation of the assigned control members will be saved and can be re-edited dynamically or be shared with friends by CD, e-mail etc. The icon B can enable or disable the video display window.

It is to be understood that the invention is not limited to the specific details described herein which are given by way of example only and that various modifications and alterations are possible without departing from the scope of the invention. The examples shown are for one embodiment of the invention only and the invention is not limited to any presentation method of the mixing layout or to any specific media type. The invention is not limited to the display or arrangement of the time axis bars, to any naming conventions for waveform, envelopes, controls, parameters, screen layouts, icon designs or display tool bar characteristics, foreground or background colour schemes, task bar features or functions, or the physical characteristics, design, number of control members, types of control members, rotatable or slider type control members, infrared activations etc. of the interactive multimedia apparatus. The example provided is an abridged presentation of a limited period in the mixing cycle and the representation example shown should not be interpreted as the facilities or presentation of a complete mixing and editing cycle. The range and diversity of controls and effects are not limited to those shown in the examples above.

1. An interactive multimedia apparatus, usable in combination with a software suite of programs installed in a computing means with a display component and a suitable input connection port to connect to the apparatus, characterised in that the apparatus includes dynamic intervention means to modify, refine, adjust, vary and/or change characteristics, parameters and special effects of individual audio or video tracks and/or characteristics and parameters and special effects of a composite audio mix during the mixing cycle in real time.

2. A multimedia apparatus as claimed in claim 1 which includes a control member, the activation of which triggers a segment of a waveform component and dynamically mixes that segment during the mix cycle.

3. A multimedia apparatus as claimed in claim 1, including means to record all the controls, parameters and special effects details of the composite mix including the dynamically applied controls, parameters and effects initiated by the activation of the control members of the interactive multimedia device, which have been affected during the mix cycle.

4. A multimedia apparatus as claimed in claim 1, including means of presenting a visual representation of each track in the mix displayed on a visual display unit and the exact position in time that the intervention occurred in the mix cycle, with highlighted blocks to indicate where addition, deletion or modifications, control changes, parameter changes and/or special effects have been applied as a result of the activation of the control member of the apparatus with the visual representation represented on the visual display unit also illustrating the control changes, parameter changes and special effects applied to the composite mix characteristics with the exact position in time where these events occurred, including means to record the initiation of any other audio/video event with a time stamp recording and means for representing the event or events together with the dynamically applied interventions.

5. A multimedia apparatus as claimed in claim 1, which comprises a device having activation means operable by a user to generate electrical signals in response to a user‘s activation and selection, the apparatus including a processor (U1), a plurality of control members (SW1-SW11), an opto-coupled rotatable control member (SW12), an output USB chip (U2), a timer crystal (A) and a plurality of resistors and capacitors, a central control unit containing firmware, operable to detect the activation of the control members (S1-S12) by the user, means to convert the control members'activations into electrical signals, and means to transmit the electrical signals to the control unit and software means for processing the signals to perform the function assigned to the control members by the user.

6. A multimedia apparatus as claimed in claim 5, including driver software means to interface with the interactive multimedia apparatus; software means to interpret the electrical signals generated as a result of the user's activation actions of the control members; mixing and editing software means to allow the user to create controls, modify and adjust the components of their mix and the overall mix composition parameter during the mixing cycle by the operation of the interactive multimedia apparatus control members; configuring means for assigning the control members for differing functionality, controls and effects; means for configuring and assigning a plurality of similar or dissimilar interactive multimedia apparatus.

7. A multimedia apparatus as claimed in claim 6, including additional mixing and editing software means to allow users to configure, define and place selected loops, riffs, beats, one-shots, video-clips, microphone inputs and the like in tracks along a time axis ruler to be mixed at that time in the mixing cycle whereby when the user commences to play the tracks of the additional mixing means, they can mix together with the resulting mix generated from the dynamic interventions from the interactive multimedia apparatus.

8. A multimedia apparatus as claimed in claim 1, including means for detecting the activation of a control member by a user and means for triggering a segment of a waveform component and dynamically mixing that segment during the mix cycle.

9. A multimedia apparatus as claimed in claim 1, including means for a user to assign the selected controls, parameters effects to a control member of their choice, with a control element assignment label being operable to display a selection of the control members available on the apparatus, means for attributing to selected controls elements, parameters and effects to be applied to the individual track or group of tracks or to the composite mix by the application program detecting the activation of the control element.

10. A multimedia apparatus as claimed in claim 1, including means for displaying a view window or windows, directories, folders and content files resulting from the software scanning the storage devices for user selected media types, thereby enabling the user to display a listing of all or selected files on the storage devices for ease of loading and selection and including means for initiating the scan process by selection of an icon label of the control device.

11. A multimedia apparatus as claimed in claim 1, including means for scanning of the storage areas for user selected me in real time, with icon means for presenting individual media component contained in the folders and/or directories and means for dragging the desired media component and placing it in a waveform display area thereby providing the facility of interrogating the storage for a user requested media type in real time.

12. An interactive multimedia apparatus as claimed in claim 1, including means to dynamically intervene in a mixing cycle to apply a sound, beat, riff, loop etc. or a segment of a loop, riff or beat of video media at any time selected by the user to provide a complementary and enhancing contribution to the mix, including means to select and mark a segment of a waveform component and dynamically mix that segment during the mix cycle, including its applied effects, controls and parameter adjustments.

13. A multimedia apparatus as claimed in claim 1, including means for recording the intervention of controls, parameters effects triggered by the activation of the control member with all the effects, controls and parameters applied and captured at the time of application and for the duration of their application, means for storing the parameters, effects and controls resulting from the activation of the control members and means for presenting on the visual display unit visual images of individual track components in their correct position in time along a time axis ruler, together with the other fixed positioned tracks placed by the user in the pre-mixing set-up, whereby the user may be presented with a visual image of the mix of tracks including the dynamically created component to allow for additional editing, mixing, effects and the like, with the video and audio components being separately displayed in tracks along the time axis ruler together with any intervention by the user of any other audio/video events.

14. A multimedia apparatus as claimed in claim 1, including a loop repository or a loop store means for all the content, which is to be triggerable by the activation of the control members, to be stored and retained, whereby loops can be combined in separate folders for easy content management or for group assignment to different triggering devices and each folder or file is activatable or deactivatable by the selection or de-selection of a flag.

15. A multimedia apparatus as claimed in claim 1 including software recording means to allow a user to transfer and record content from pre-recorded media, microphone input, television receiver and radio broadcast, whereby content can be pre-edited for static or dynamic mixing purposes.

16. A multimedia apparatus as claimed in claim 14, in which data for the loop repository is obtainable from pre-recorded media, the internet, TV channels, radio broadcasts, web-cams, and/or digital media cameras and placed directly into a folder in the loop repository, including means to pre-edit a small section of sound, video, or sound and video and place it in the loop repository, the apparatus including a means to cut and paste a section of sound, video or sound and video from a composition and drop that selection directly into the loop repository and including means to adjust individual properties, such as volume, tempo, mute, loop and pan, of each multi-media component in the loop repository.

17. A multimedia apparatus as claimed in claim 16, including means to assign controls, effects and parameters to the loops, so that a user may activate them at the desired time in the mix and the associated assigned controls, parameters and effects that a user wishes to apply to these loops.

18. A multimedia apparatus as claimed in claim 1 including diagnostic means for identifying the correct operation and functions of the elements and means of the apparatus for support and maintenance purposes.

19. A multimedia apparatus as claimed in claim 1 in which the control unit is a personal computer, a hand held computer, a music playing device with processing power, a mobile telephone device (particularly a 2.5 G or 3 G mobile telephone where an audio output is available), a personal digital organiser, a games console, a set top box device or any device with the necessary processing power to run the application program and having a visual display unit and the means to convert digital audio to analogue sound output, the control unit means to store hold riffs, loops, beats, one-shots, etc. and memory space with sufficient working space to run the application.

20. A multimedia apparatus as claimed in claim 19, in which the control unit has a suitable connection port for connection to the interactive multimedia device such as USB, serial, parallel, bluetooth, firewire or any connection method suitable for the apparatus.

21. A multimedia apparatus as claimed in claim 19 which is configured for mobile use and in which the dynamic mixing control elements are integrated in the housing of the apparatus and form a single composite unit with application software means being ported to apparatus, so as to allow the user to enjoy a mixing experience in a mobile environment.

22. A multimedia apparatus as claimed in claim 1, including a foot operated control member, in which the foot operated control members are configurable and assignable to the software means so as to be operable by the activation of the control members.

23. A multimedia apparatus as claimed in claim 1, in which the apparatus is a dance-mat in which the mat includes control members placed within coloured segments of the mat or platform and the control members are activatable by the pressure of the foot, with the dance-mat or platform having control members under each coloured segment assignable and configurable to the control members.

24. A multimedia apparatus as claimed in claim 1 in which the apparatus is a steering wheel device in which assignable control members are provided about the steering wheel device.

25. A multimedia apparatus substantially in accordance with any of the embodiments as herein described with reference to and as shown in the accompanying drawings.
